(19) United States
(12) Patent Application Publication
(10) Pub. No.: US 2016/0275968 A1
(43) Pub. Date: Sep. 22, 2016

(54) SPEECH DETECTION DEVICE, SPEECH DETECTION METHOD, AND MEDIUM

(71) Applicant: NEC CORPORATION, Tokyo (JP)

(72) Inventors: Makoto TERAO, Tokyo (JP); Masanori TSUJIKAWA, Tokyo (JP)

(21) Appl. No.: 15/030,114

(22) PCT Filed: May 8, 2014
(86) PCT No.: PCT/JP2014/062361

§ 371 Date: Apr. 18, 2016

(30) Foreign Application Priority Data
Oct. 22, 2013 (JP) 2013-218935

(51) Int. Cl. G10L 25/84; G10L 15/18; G10L 15/02; G10L 15/06; G10L 25/21

(52) U.S. Cl. CPC G10L 25/84; G10L 15/063; G10L 25/21; G10L 15/02; G10L 15/18; G10L 2015/025

(57) ABSTRACT

A speech detection device according to the present invention acquires an acoustic signal, calculates a feature value representing a spectrum shape for a plurality of first frames from the acoustic signal, calculates a ratio of a likelihood of a voice model to a likelihood of a non-voice model for the first frames using the feature value, determines a candidate target voice section that is a section including target voice by use of the likelihood ratio, calculates a posterior probability of a plurality of phonemes using the feature value, calculates at least one of entropy and time difference of posterior probabilities of the plurality of phonemes for the first frames, and specifies a section as changed to a section not including the target voice, out of the candidate target voice sections, by use of at least one of the entropy and the time difference of the posterior probabilities.

### TECHNICAL FIELD

The present invention relates to a speech detection device, a speech detection method, and a program.

### BACKGROUND ART

A voice section detection technology is a technology of detecting a time section in which voice (human voice) exists from an acoustic signal. Voice section detection plays an important role in various types of acoustic signal processing. For example, in speech recognition, insertion errors may be suppressed and voice may be recognized while reducing a processing amount, by taking only a detected voice section as a recognition target. In noise tolerance processing, sound quality of a voice section may be increased by estimating a noise component from a non-voice section in which voice is not detected. In voice coding, a signal may be efficiently compressed by coding only a voice section.

The voice section detection technology is a technology of detecting voice. However, in general, unintended voice is treated as noise, despite being voice, and is not treated as a detection target. For example, when voice detection is used for performing speech recognition on conversational content via a mobile phone, voice to be detected is voice generated by a user of the mobile phone. As for voice included in an acoustic signal transmitted/received by a mobile phone, various types of voice may be considered in addition to voice generated by the user of the mobile phone, such as voice in conversations of people around the user, announcement voice in station premises, and voice generated by a TV. Such voice types should not be detected. Voice as a target of detection is hereinafter referred to as “target voice” and voice treated as noise instead of a target of detection is referred to as “voice noise.” Further, various types of noise and silence may be collectively referred to as “non-voice.”

NPL 1 mentioned below proposes a technique of determining whether each frame in an acoustic signal is voice or non-voice in order to increase voice detection precision in a noise environment by comparing a predetermined threshold value with a weighted sum of four scores calculated in accordance with respective features of an acoustic signal as follows: an amplitude level, a number of zero crossings, spectrum information, and a log-likelihood ratio between a voice GMM and a non-voice GMM with a mel-cepstrum coefficient as an input.

### CITATION LIST

### Patent Literature

[PLT 1] Japanese Patent No. 4282227

### Non Patent Literature

[NPL 1] Yusuke Kida and Tatsuya Kawahara, “Voice Activity Detection based on Optimally Weighted Combination of Multiple Features,” Proc. INTERSPEECH 2005, pp. 2621-2624, 2005

### SUMMARY OF INVENTION

### Technical Problem

However, the aforementioned proposed technique described in NPL 1 may erroneously detect noise not learned as a non-voice GMM, as target voice. The reason is that, in the aforementioned proposed technique, a likelihood of a non-voice GMM is small for noise not learned as a non-voice GMM, and therefore a log-likelihood ratio between the voice GMM and the non-voice GMM becomes large and the noise is erroneously determined as voice.

For example, it is considered to detect voice in an environment in which a train traveling sound exists. When a train traveling sound is included in learning acoustic data of a non-voice GMM, a likelihood of the non-voice GMM is large in a section in which the train traveling sound exists. Consequently, a log-likelihood ratio between the voice GMM and the non-voice GMM becomes small and the aforementioned technique is able to correctly determine the section as non-voice. However, when a train traveling sound is not included in the learning acoustic data of the non-voice GMM, the likelihood of the non-voice GMM is small in a section in which the train traveling sound exists. Consequently, the log-likelihood ratio between the voice GMM and the non-voice GMM becomes large and the aforementioned technique erroneously detects the train traveling sound as voice.

The present invention is made in view of such a situation and provides a voice detection technology of detecting a target voice section with high precision, without erroneously detecting noise not learned as a non-voice model, as a voice section.

### Solution to Problem

According to the present invention, a speech detection device is provided. The speech detection device includes:
acoustic signal acquisition means for acquiring an acoustic signal;
voice section detection means including
   spectrum shape feature calculation means for performing a process of calculating a feature value representing a spectrum shape for each of a plurality of first frames obtained from the acoustic signal,
   likelihood ratio calculation means for calculating a ratio of a likelihood of a voice model to a likelihood of a non-voice model for each of the plurality of first frames using the feature value as an input, and
   section determination means for determining a candidate target voice section that is a section including a target voice by use of the ratio of a likelihood of a voice model to a likelihood of a non-voice model;
posterior probability calculation means for performing a process of calculating a posterior probability of each of a plurality of phonemes using the feature value as an input;
posterior-probability-based feature calculation means for calculating at least one of entropy and time difference of posterior probabilities of the plurality of phonemes for each of the plurality of first frames; and
rejection means for specifying a section to be changed to a section not including the target voice, out of the candidate target voice sections, by use of at least one of the entropy and the time difference of the posterior probabilities.

According to the present invention, a speech detection method performed by a computer is provided. The method includes:
an acoustic signal acquisition step of acquiring an acoustic signal;
a voice section detection step including
   a spectrum shape feature calculation step of performing a process of calculating a feature value representing a spectrum shape for each of a plurality of first frames obtained from the acoustic signal,
   a likelihood ratio calculation step of calculating a ratio of a likelihood of a voice model to a likelihood of a non-voice model for each of the plurality of first frames using the feature value as an input, and
   a section determination step of determining a candidate target voice section that is a section including a target voice by use of the ratio of a likelihood of a voice model to a likelihood of a non-voice model;
a posterior probability calculation step of performing a process of calculating a posterior probability of each of a plurality of phonemes using the feature value as an input;
a posterior-probability-based feature calculation step of calculating at least one of entropy and time difference of posterior probabilities of the plurality of phonemes for each of the plurality of first frames; and
a rejection step of specifying a section to be changed to a section not including the target voice, out of the candidate target voice sections, by use of at least one of the entropy and the time difference of the posterior probabilities.

According to the present invention, a program is provided. The program causes a computer to function as:
acoustic signal acquisition means for acquiring an acoustic signal;
voice section detection means including
   spectrum shape feature calculation means for performing a process of calculating a feature value representing a spectrum shape for each of a plurality of first frames obtained from the acoustic signal,
   likelihood ratio calculation means for calculating a ratio of a likelihood of a voice model to a likelihood of a non-voice model for each of the plurality of first frames using the feature value as an input, and
   section determination means for determining a candidate target voice section that is a section including a target voice by use of the ratio of a likelihood of a voice model to a likelihood of a non-voice model;
posterior probability calculation means for performing a process of calculating a posterior probability of each of a plurality of phonemes using the feature value as an input;
posterior-probability-based feature calculation means for calculating at least one of entropy and time difference of posterior probabilities of the plurality of phonemes for each of the plurality of first frames; and
rejection means for specifying a section to be changed to a section not including the target voice, out of the candidate target voice sections, by use of at least one of the entropy and the time difference of the posterior probabilities.

### Advantageous Effects of Invention

The present invention enables highly precise detection of a target voice section, without erroneously detecting noise not learned as a non-voice model, as a voice section.

### BRIEF DESCRIPTION OF DRAWINGS

The abovementioned object, other objects, features and advantages will become more apparent by the following preferred exemplary embodiments and the accompanying drawings.

FIG. 1 is a diagram conceptually illustrating a configuration example of a speech detection device according to a first exemplary embodiment.

FIG. 2 is a diagram illustrating a specific example of processing of extracting a plurality of frames from an acoustic signal.

FIG. 3 is a flowchart illustrating an operation example of the speech detection device according to the first exemplary embodiment.

FIG. 4 is a diagram illustrating a success example of voice detection based on likelihood ratio.

FIG. 5 is a diagram illustrating a success example of non-voice detection based on likelihood ratio.

FIG. 6 is a diagram illustrating a failure example of non-voice detection based on likelihood ratio.

FIG. 7 is a diagram conceptually illustrating a configuration example of a speech detection device according to a second exemplary embodiment.

FIG. 8 is a flowchart illustrating an operation example of the speech detection device according to the second exemplary embodiment.

FIG. 9 is a diagram conceptually illustrating a configuration example of a speech detection device according to a third exemplary embodiment.

FIG. 10 is a diagram illustrating a specific example of processing of a section determination unit according to the third exemplary embodiment.

FIG. 11 is a flowchart illustrating an operation example of the speech detection device according to the third exemplary embodiment.

FIG. 12 is a diagram illustrating an effect of the speech detection device according to the third exemplary embodiment.

FIG. 13 is a diagram conceptually illustrating a configuration example of a speech detection device according to a fourth exemplary embodiment.

FIG. 14 is a diagram illustrating a specific example of first and second sectional shaping units according to the fourth exemplary embodiment.

FIG. 15 is a flowchart illustrating an operation example of the speech detection device according to the fourth exemplary embodiment.

FIG. 16 is a diagram illustrating a specific example of two types of voice determination results integrated after respectively undergoing sectional shaping.

FIG. 17 is a diagram illustrating a specific example of two types of voice determination results undergoing sectional shaping after being integrated.

FIG. 18 is a diagram illustrating a specific example of a time series of a sound level and a likelihood ratio under station announcement noise.

FIG. 19 is a diagram illustrating a specific example of a time series of a sound level and a likelihood ratio under door-opening/closing noise.

FIG. 20 is a diagram conceptually illustrating a configuration example of a speech detection device according to a fifth exemplary embodiment.

FIG. 21 is a diagram conceptually illustrating an example of a hardware configuration of a speech detection device according to the present exemplary embodiments.

### DESCRIPTION OF EMBODIMENTS

First, an example of a hardware configuration of a speech detection device according to the present exemplary embodiments will be described.

The speech detection device according to the present exemplary embodiments may be a portable device or a stationary device. Each unit included in the speech detection device according to the present exemplary embodiments is implemented by use of any combination of hardware and software, in any computer, mainly including a central processing unit (CPU), a memory, a program (including a program downloaded from a storage medium such as a compact disc [CD], a server connected to the Internet, and the like, in addition to a program stored in a memory in advance from a device shipping stage) loaded into a memory, a storage unit, such as a hard disk, storing the program, or a network connection interface. It should be understood by those skilled in the art that various modified examples of the implementation method and the device may be available.

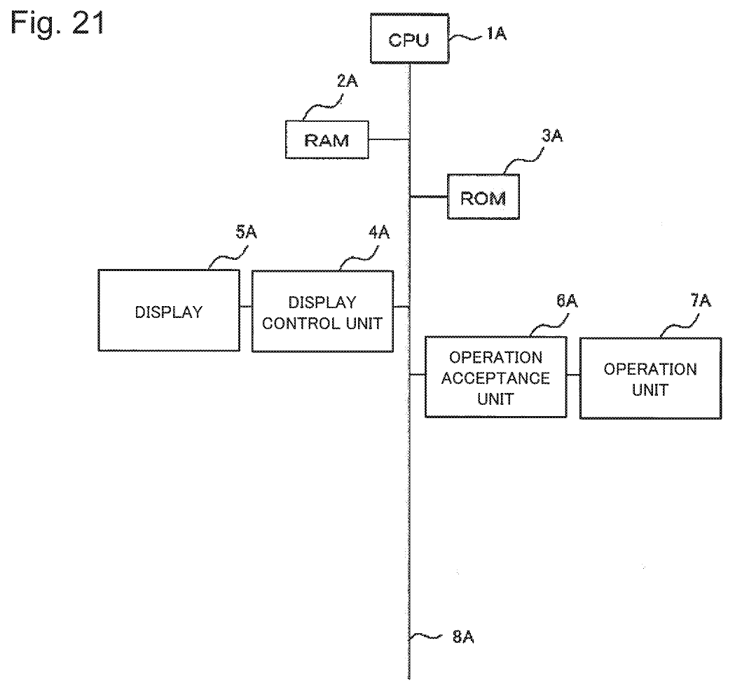

FIG. 21 is a diagram conceptually illustrating an example of a hardware configuration of the speech detection device according to the present exemplary embodiments. As illustrated, the speech detection device according to the present exemplary embodiments includes, for example, a CPU 1A, a random access memory (RAM) 2A, a read only memory (ROM) 3A, a display control unit 4A, a display 5A, an operation acceptance unit 6A, and an operation unit 7A, interconnected by a bus 8A. Although not being illustrated, the speech detection device according to the present exemplary embodiments may include an additional element such as an input/output I/F connected to an external apparatus in a wired manner, a communication unit for communicating with an external apparatus in a wired and/or wireless manner, a microphone, a speaker, a camera, and an auxiliary storage device.

The CPU 1A controls an entire computer in the electronic device along with each element. The ROM 3A includes an area storing a program for operating the computer, various application programs, various setting data used when those programs operate, and the like. The RAM 2A includes an area temporarily storing data, such as a work area for program operation.

The display 5A includes a display device (such as a light emitting diode [LED] indicator, a liquid crystal display, and an organic electro luminescence [EL] display). The display 5A may be a touch panel display integrated with a touch pad. The display control unit 4A reads data stored in a video RAM (VRAM), performs predetermined processing on the read data, and, subsequently transmits the data to the display 5A for various kinds of screen display. The operation acceptance unit 6A accepts various operations through the operation unit 7A. The operation unit 7A includes an operation key, an operation button, a switch, a jog dial, and a touch panel display.

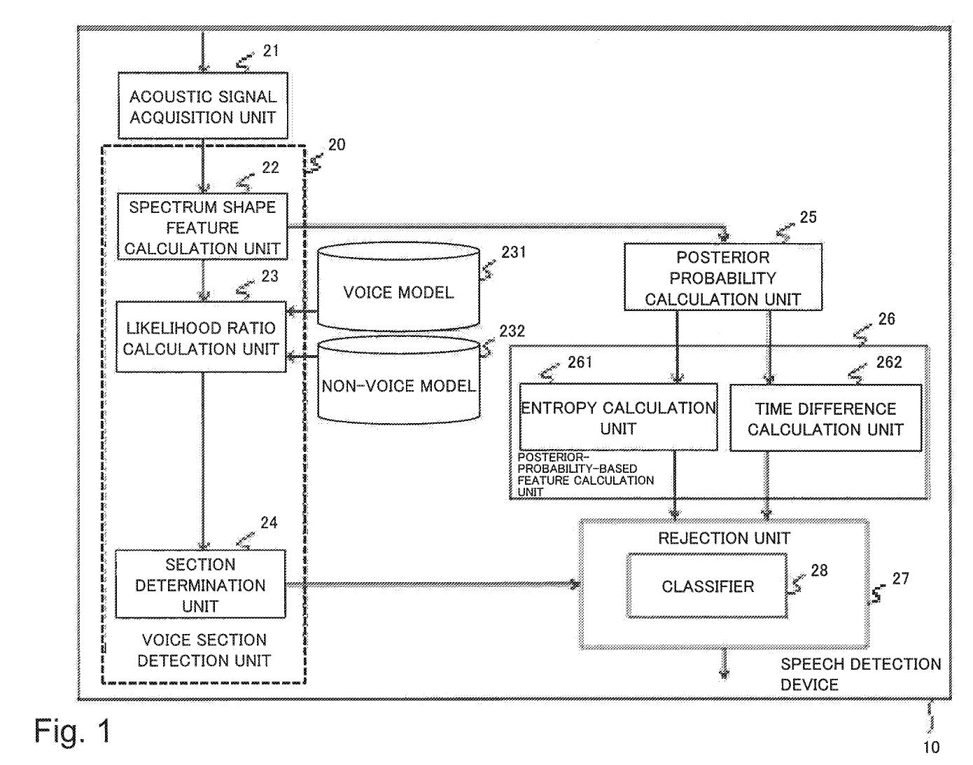

The present exemplary embodiments will be described below. Functional block diagrams (FIGS. 1, 7, 9, and 13) used in the following descriptions of the exemplary embodiments illustrate blocks on a functional basis instead of configurations on a hardware basis. Each device is described to be implemented by use of a single apparatus in the drawings. However, the implementation method is not limited thereto. In other words, each device may have a physically separated configuration or a logically separated configuration.

### First Exemplary Embodiment

### Processing Configuration

FIG. 1 is a diagram conceptually illustrating a processing configuration example of a speech detection device 10 according to a first exemplary embodiment. The speech detection device 10 according to the first exemplary embodiment includes an acoustic signal acquisition unit 21, a voice section detection unit 20, a voice model 231, a non-voice model 232, a posterior probability calculation unit 25, a posterior-probability-based feature calculation unit 26, and a rejection unit 27. The voice section detection unit 20 includes a spectrum shape feature calculation unit 22, a likelihood ratio calculation unit 23, and a section determination unit 24. The posterior-probability-based feature calculation unit 26 includes an entropy calculation unit 261 and a time difference calculation unit 262. The rejection unit 27 may include a classifier 28 as illustrated.

The acoustic signal acquisition unit 21 acquires an acoustic signal as a processing target and extracts a plurality of frames from the acquired acoustic signal. The acoustic signal acquisition unit 21 may acquire an acoustic signal from a microphone attached to the speech detection device 10 in real time, or may acquire a prerecorded acoustic signal from a recording medium, an auxiliary storage device included in the speech detection device 10, or the like. Further, the acoustic signal acquisition unit 21 may acquire an acoustic signal from a computer other than the computer performing the voice detection processing, via a network.

An acoustic signal is time-series data. A partial chunk in an acoustic signal is hereinafter referred to as “section.” Each section is specified/expressed by a section start point and a section end point. A section start point (start frame) and a section end point (end frame) of each section may be expressed by use of identification information (such as a serial number of a frame) of respective frames extracted (obtained) from an acoustic signal, by an elapsed time from the start point of an acoustic signal, or by another technique.

A time-series acoustic signal may be categorized into a section including detection target voice (hereinafter referred to as “target voice”) (hereinafter referred to as “target voice section”) and a section not including target voice (hereinafter referred to as “non-target voice section”). When an acoustic signal is observed in a chronological order, a target voice section and a non-target voice section appear alternately. An object of the speech detection device 10 according to the present exemplary embodiment is to specify a target voice section in an acoustic signal.

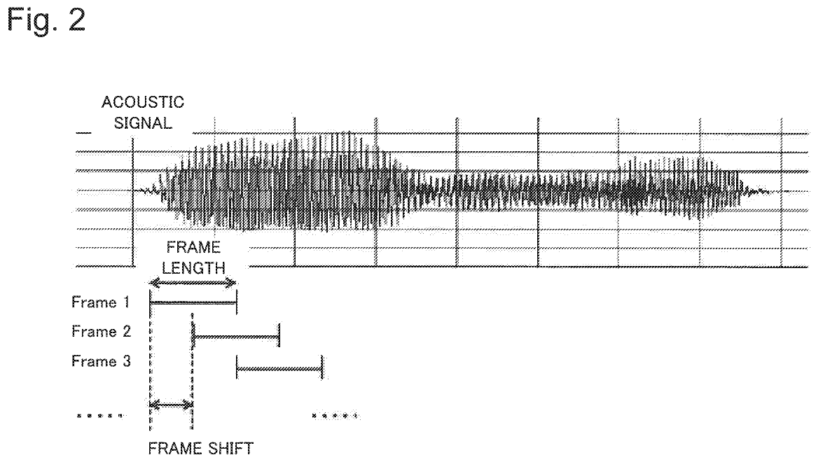

FIG. 2 is a diagram illustrating a specific example of processing of extracting a plurality of frames from an acoustic signal. A frame refers to a short time section in an acoustic signal. The acoustic signal acquisition unit 21 extracts a plurality of frames from an acoustic signal by sequentially shifting a section having a predetermined frame length by a predetermined frame shift length. Normally, adjacent frames are extracted so as to overlap one another. For example, the acoustic signal acquisition unit 21 may use 30 msec as a frame length and 10 msec as a frame shift length.

For each of a plurality of frames (first frames) extracted by the acoustic signal acquisition unit 21, the spectrum shape feature calculation unit 22 performs a process of calculating a feature value representing a frequency spectrum shape of the first frame signal. The spectrum shape feature calculation unit 22 may use known feature values commonly used in an acoustic model in speech recognition such as a mel-frequency cepstrum coefficient (MFCC), a linear prediction coefficient (LPC coefficient), a perceptive linear prediction coefficient (PLP coefficient), and time difference (A, AA) of the coefficients, as a feature value representing a frequency spectrum shape. Such feature values are also known to be effective for classification of voice and non-voice.

The likelihood ratio calculation unit 23 calculates A being a ratio of a likelihood of a voice model 231 to a likelihood of a non-voice model 232 (may hereinafter simply referred to as “likelihood ratio” or “voice-to-non-voice likelihood ratio”), with a feature value calculated for each first frame by the spectrum shape feature calculation unit 22 as an input. The likelihood ratio A is calculated by an equation expressed by equation 1.

$$Λ = \frac{p ( {x}_{t} \vert {Θ}_{s} )}{p ( {x}_{t} \vert {Θ}_{n} )} \qquad [ Equation 1 ]$$

Note that xt denotes an input feature value, Θs denotes a voice model parameter, and Θn denotes a non-voice model parameter. The likelihood ratio may be calculated as a log-likelihood ratio.

The voice model 231 and the non-voice model 232 are learned in advance by use of a learning acoustic signal in which a voice section and a non-voice section are labeled. It is preferable that much noise assumed in an environment to which the speech detection device 10 is applied is included in a non-voice section of the learning acoustic signal. As a model, for example, a Gaussian mixture model (GMM) is used. A model parameter may be learned in accordance with maximum likelihood estimation.

The section determination unit 24 detects a candidate for a target voice section including target voice by use of a likelihood ratio calculated by the likelihood ratio calculation unit 23. For example, the section determination unit 24 compares a likelihood ratio with a predetermined threshold value for each first frame. Then, the section determination unit 24 determines a first frame having a likelihood ratio greater than or equal to the threshold value as a candidate for a first frame including target voice (hereinafter referred to as “first target frame”), and determines a first frame having a likelihood ratio less than the threshold value as a candidate for a first frame not including target voice (hereinafter referred to as “first non-target frame”).

Then, the section determination unit 24 determines a section corresponding to a first target frame as a “candidate target voice section,” in accordance with the determination result. The candidate target voice section may be specified/expressed by identification information of a first target frame. For example, when first target frames have frame numbers 6 to 9, 12 to 19, . . . , candidate target voice sections are expressed by frame numbers 6 to 9, 12 to 19, . . . .

Additionally, a candidate target voice section may be specified/expressed by use of an elapsed time from the start point of an acoustic signal. In this case, a section corresponding to the first target frame needs to be expressed by an elapsed time from the start point of the acoustic signal. An example of expressing a section corresponding to each frame by an elapsed time from the start point of an acoustic signal will be described below.

A section corresponding to each frame is at least part of a section extracted from an acoustic signal by the each frame. As described by use of FIG. 2, a plurality of frames (first frames) may be extracted so as to overlap with adjacent frames. In such a case, a section corresponding to each frame is part of a section extracted by the each frame. Which of the sections extracted by each frame is to be taken as a corresponding section is a design matter. For example, in case of a frame length 30 msec and a frame shift length 10 msec, a frame extracting a 0 (start point) to 30 msec part in an acoustic signal, a frame extracting a 10 msec to 40 msec part, a frame extracting a 20 msec to 50 msec part, and the like exist. In this case, for example, 0 to 10 msec in the acoustic signal may be taken as a section corresponding to the frame extracting the 0 (start point) to 30 msec part, 10 msec to 20 msec in the acoustic signal as a section corresponding to the frame extracting the 10 msec to 40 msec part, and 20 msec to 30 msec in the acoustic signal as a section corresponding to the frame extracting the 20 msec to 50 msec part. Thus, a section corresponding to a given frame does not overlap with a section corresponding to another frame. When a plurality of frames (first frames) are extracted so as not to overlap with adjacent frames, an entire part extracted by each frame may be taken as a section corresponding to the each frame.

With a feature value calculated by the spectrum shape feature calculation unit 22 as an input, the posterior probability calculation unit 25 calculates posterior probabilities p(qk|xt) of a plurality of phonemes by use of the voice model 231 for each of a plurality of first frames. Note that xt denotes a feature value at a time t and qk denotes a phoneme k. In FIG. 1, the voice model used by the likelihood ratio calculation unit 23 and the voice model used by the posterior probability calculation unit 25 are common. However, the likelihood ratio calculation unit 23 and the posterior probability calculation unit 25 may respectively use different voice models. Further, the spectrum shape feature calculation unit 22 may calculate different feature values between a feature value used by the likelihood ratio calculation unit 23 and a feature value used by the posterior probability calculation unit 25.

As a voice model to be used, the posterior probability calculation unit 25 may use, for example, a Gaussian mixture model learned for each phoneme (phoneme GMM). The posterior probability calculation unit 25 may learn a phoneme GMM by use of, for example, learning voice data assigned with phoneme labels such as /a/, /i/, /u/, /e/, /o/. By assuming the prior probability of each phoneme p(qk) to be identical regardless of a phoneme k, the posterior probability calculation unit 25 is able to calculate the posterior probability p(qk|xt) of a phoneme qk at a time t by use of equation 2 using the likelihood p(xt|qk) of a phoneme GMM.

$$p ( {q}_{k} \vert {x}_{t} ) = \frac{p ( {x}_{t} \vert {q}_{k} )}{{\sum }_{q} p ( {x}_{t} \vert q )} \qquad [ Equation 2 ]$$

The calculation method of the phoneme posterior probability is not limited to a method using a GMM. For example, the posterior probability calculation unit 25 may learn a model directly calculating the phoneme posterior probability by use of a neural network.

Further, without assigning phoneme labels to learning voice data, the posterior probability calculation unit 25 may automatically learn a plurality of models corresponding to phonemes from the learning data. For example, the posterior probability calculation unit 25 may learn a GMM by use of learning voice data including only human voice, and simulatively consider each of the learned Gaussian distributions as a phoneme model. For example, when the posterior probability calculation unit 25 learns a GMM with a number of mixture components being 32, the 32 learned single Gaussian distributions can be simulatively considered as a model representing features of a plurality of phonemes. A “phoneme” in this context is different from a phoneme phonologically defined by humans. However, a “phoneme” according to the present exemplary embodiment may be, for example, a phoneme automatically learned from learning data, in accordance with the method described above.

The posterior-probability-based feature calculation unit 26 includes an entropy calculation unit 261 and a time difference calculation unit 262. The entropy calculation unit 261 performs a process of calculating entropy E(t) at a time t for respective first frames by use of equation 3 using the posterior probabilities p(qk|xt) of a plurality of phonemes calculated by the posterior probability calculation unit 25.

$$E ( t ) = - {\sum }_{k} p ( {q}_{k} \vert {x}_{t} ) log ( {q}_{k} \vert {x}_{t} ) \qquad [ Equation 3 ]$$

The entropy of phoneme posterior probability becomes smaller as the posterior probability becomes more concentrated on a specific phoneme. In a voice section composed of a sequence of phonemes, the posterior probability is concentrated on a specific phoneme, and therefore the entropy of phoneme posterior probability is small. By contrast, in a non-voice section, the posterior probability is less likely to be concentrated on a specific phoneme, and therefore the entropy of phoneme posterior probability is large.

The time difference calculation unit 262 calculates time difference D(t) at a time t for each first frame by use of equation 4 using the posterior probabilities p(qk|xt) of a plurality of phonemes calculated by the posterior probability calculation unit 25.

$$D ( t ) = {\sum }_{k} {\{ p ( {q}_{k} \vert {x}_{t} ) - p ( {q}_{k} \vert {x}_{t - 1} ) \}}^{2} \qquad [ Equation 4 ]$$

The calculation method of the time difference of phoneme posterior probability is not limited to equation 4. For example, instead of calculating a square sum of time difference values of each phoneme posterior probability, the posterior probability calculation unit 25 may calculate a sum of absolute time difference values.

The time difference of phoneme posterior probability becomes larger as time variation of a posterior probability distribution becomes larger. In a voice section, phonemes continually change in a short time of several tens of milliseconds. Consequently, the time difference of phoneme posterior probability is large. By contrast, in a non-voice section, features do not greatly change in a short time from a phoneme point of view. Consequently, the time difference of phoneme posterior probability is small.

By use of at least one of the entropy and the time difference of phoneme posterior probability calculated by the posterior-probability-based feature calculation unit 26, the rejection unit 27 determines whether to output a candidate target voice section detected by the section determination unit 24 as a final detection section (target voice section) or reject (change to a section not being a target voice section) the section. In other words, the rejection unit 27 specifies a section to be changed to a section not including target voice out of candidate target voice sections, by use of at least one of the entropy and the time difference of posterior probability.

As described above, there is a feature in a voice section that the entropy of phoneme posterior probability is small and the time difference of phoneme posterior probability is large. There is an opposite feature in a non-voice section. Consequently, by use of one or both of the entropy and the time difference, the rejection unit 27 is able to classify whether a candidate target voice section determined by the section determination unit 24 is voice or non-voice.

One or more than one candidate target voice sections separated from one another may exist in an acoustic signal (for example: a first candidate target voice section has frame numbers 6 to 9, a second candidate target voice section has frame numbers 12 to 19, . . . ). By averaging the entropy of phoneme posterior probability for each candidate target voice section, the rejection unit 27 may calculate averaged entropy. Similarly, by averaging the time difference of phoneme posterior probability for each candidate target voice section, the rejection unit 27 may calculate averaged time difference. Then, by use of the averaged entropy and the averaged time difference, the rejection unit 27 may classify whether each candidate target voice section is voice or non-voice. In other words, the rejection unit 27 may perform a process of calculating an average value of at least one of the entropy and the time difference of posterior probability for each of a plurality of candidate target voice sections separated from one another in an acoustic signal. Then, by use of the calculated average value, the rejection unit 27 may determine whether or not to take each of the plurality of candidate target voice sections as a section not including target voice.

Although, as described above, the entropy of phoneme posterior probability tends to be small in a voice section, some frame having large entropy exists. By averaging the entropy in a plurality of frames across an entire candidate target voice section, the rejection unit 27 is able to determine whether each candidate target voice section is voice or non-voice with yet higher precision. Similarly, although the time difference of phoneme posterior probability tends to be large in a voice section, some frame having small time difference exists. By averaging the time difference in a plurality of frames across an entire candidate target voice section, the rejection unit 27 is able to determine whether the each candidate target voice section is voice or non-voice with yet higher precision. The present exemplary embodiment increases precision by determining voice or non-voice for each candidate target voice section instead of each frame.

As classification of each candidate target voice section, the rejection unit 27 may, for example, classify the target voice section as non-voice (change to a section not including target voice) when at least one or both of the following conditions are met: the averaged entropy is larger than a predetermined threshold value, and the averaged time difference is less than another predetermined threshold value.

As another classification method of a candidate target voice section, the rejection unit 27 may classify whether or not a candidate target voice section includes voice by use of, for example, a classifier 28 having at least one of the averaged entropy and the averaged time difference as a feature. As the classifier 28, the rejection unit 27 may use a GMM, logistic regression, a support vector machine, or the like. As learning data for the classifier 28, the rejection unit 27 may use learning acoustic data composed of a plurality of acoustic signal sections labeled as voice or non-voice.

Further, more preferably, the rejection unit 27 may apply the voice section detection unit 20 to first learning acoustic data composed of various acoustic signals including target voice, take data labeled as voice or non-voice for a plurality of candidate target voice sections separated from one another detected by the section determination unit 24 as second learning acoustic data, and learn the classifier 28 by use of the second learning acoustic data. By thus providing learning data for the classifier 28, the rejection unit 27 is able to learn the classifier dedicated to classifying whether an acoustic signal determined to be a voice section by the voice section detection unit 20 is truly voice or non-voice, and therefore is able to make yet more precise determination.

In the speech detection device 10 according to the first exemplary embodiment, the rejection unit 27 determines whether a candidate target voice section output from the section determination unit 24 is voice or non-voice, and when determining as voice, outputs the candidate target voice section as a target voice section. Meanwhile, when the candidate target voice section is determined as non-voice, the candidate target voice section is changed to a section not being a target voice section and is not output as a target voice section.

### Operation Example

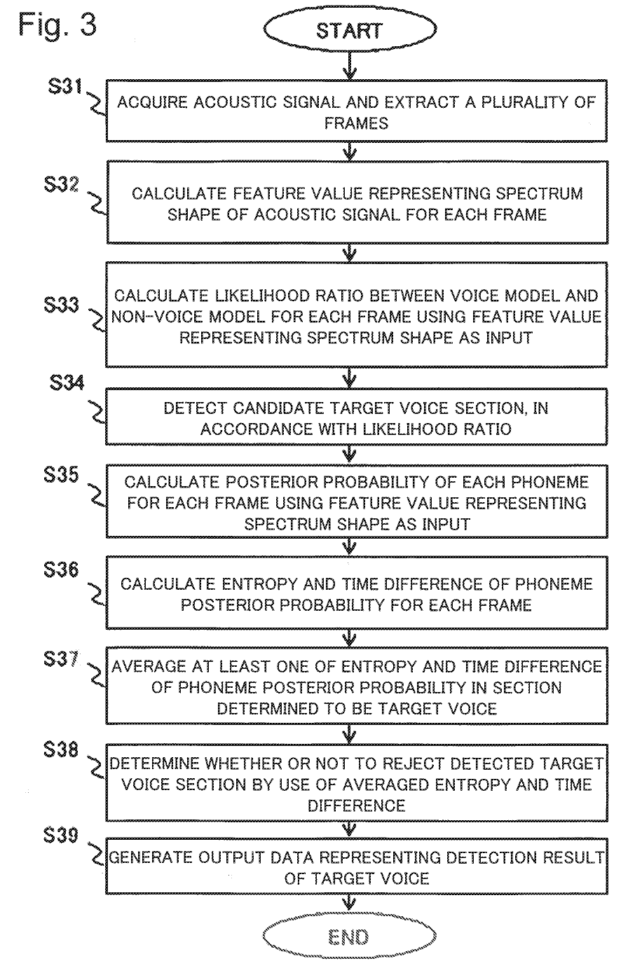

A speech detection method according to the first exemplary embodiment will be described below by use of FIG. 3. FIG. 3 is a flowchart illustrating an operation example of the speech detection device 10 according to the first exemplary embodiment.

The speech detection device 10 acquires an acoustic signal being a processing target and extracts a plurality of frames from the acoustic signal (S31). The speech detection device 10 may acquire an acoustic signal from a microphone attached to the apparatus in real time, acquire acoustic data prerecorded in a storage device medium or the speech detection device 10, or acquire an acoustic signal from another computer via a network.

Next, for each frame extracted in S31, the speech detection device 10 calculates a feature value representing a frequency spectrum shape of the signal of the frame (S32).

Next the speech detection device 10 calculates a likelihood ratio between the voice model 231 and the non-voice model 232 for each frame with the feature value calculated in S32 as an input (S33). The voice model 231 and the non-voice model 232 are created in advance in accordance with learning by use of a learning acoustic signal

Next, the speech detection device 10 detects a candidate target voice section from the acoustic signal by use of the likelihood ratio calculated in S33 (S34).

Next, the speech detection device 10 calculates the posterior probabilities of a plurality of phonemes for each frame with the feature value calculated in S32 as an input by use of the voice model 231 (S35). The voice model 231 is created in advance in accordance with learning by use of a learning acoustic signal

Next, the speech detection device 10 calculates at least one of the entropy and the time difference of phoneme posterior probability for each frame by use of the phoneme posterior probabilities calculated in S35 (S36).

Next, the speech detection device 10 performs a process of calculating an average value of at least one of the entropy and the time difference of phoneme posterior probability calculated in S36 for the candidate target voice section detected in S34 (S37).

Next, the speech detection device 10 classifies whether the candidate target voice section detected in S34 is voice or non-voice by use of at least one of the averaged entropy and the averaged time difference calculated in S37. The speech detection device 10 determines the candidate target voice section classified as voice as a target voice section, and determines the candidate target voice section classified as non-voice not to be a target voice section (S38).

Next, the speech detection device 10 generates output data representing the determination result in S38 (S39). In other words, the speech detection device 10 outputs information distinguishing between a section determined as a target voice section in S38 and the other section (non-target voice section) in the acoustic signal. Each section may be specified/expressed by, for example, frame identification information or may be specified/expressed by an elapsed time from the start point of the acoustic signal. The output data may be data to be output to another application using a voice detection result such as speech recognition, noise tolerance processing, or coding processing, or data to be displayed on a display and the like.

### Operations and Effects of First Exemplary Embodiment

As described above, the first exemplary embodiment first tentatively detects a voice section based on likelihood ratio, and then determines whether the tentatively detected section is voice or non-voice by use of at least one of the entropy and the time difference of phoneme posterior probability. Therefore, even in a situation in which noise not learned as a non-voice model exists in an acoustic signal, the first exemplary embodiment is able to detect a target voice section with high precision without erroneously detecting such noise as target voice. The reason will be described in detail below.

As a common feature of a technique of detecting a voice section by use of a voice-to-non-voice likelihood ratio, there is a problem that voice detection precision decreases when noise is not learned as a non-voice model. Specifically, the technique described above erroneously detects a noise section not learned as a non-voice model, as a voice section.

The speech detection device 10 according to the first exemplary embodiment detects a voice section by use of a voice-to-non-voice likelihood ratio, and also determines whether a section is voice or non-voice without use of any knowledge of a non-voice model but by use of properties of voice only. Therefore, the speech detection device 10 according to the first exemplary embodiment is capable of determination very robust to a noise type. Properties of voice refer to the aforementioned two features, that is, voice is composed of a sequence of phonemes, and phonemes continually change in a short time of several tens of milliseconds in a voice section. Determining whether a certain acoustic signal section has the two features, in accordance with the entropy and the time difference of phoneme posterior probability, enables determination independent of a noise type.

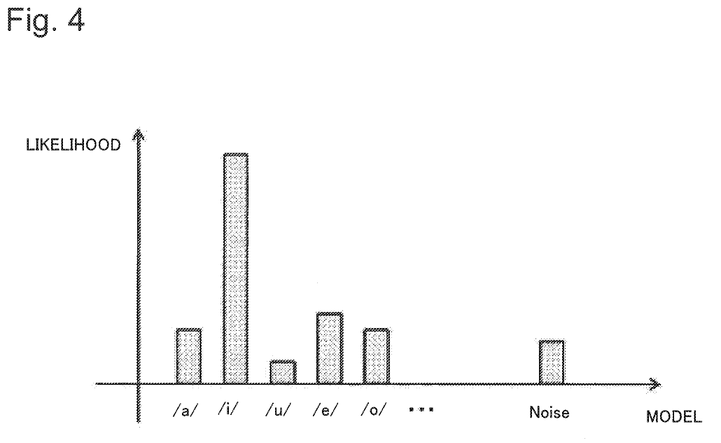

By use of FIGS. 4 to 6, effectiveness of the entropy of phoneme posterior probability for distinction between voice and non-voice will be described below. FIG. 4 is a diagram illustrating a specific example of the likelihood of a voice model (a phoneme model with phonemes /a/, /i/, /u/, /e/, /o/, . . . in the drawing) and a non-voice model (Noise model in the drawing) in a voice section. As illustrated, in the voice section, the likelihood of the voice model is large (likelihood of the phoneme /i/ is large in the drawing), and therefore the voice-to-non-voice likelihood ratio is large. Consequently, the section may be correctly determined as voice, in accordance with the likelihood ratio.

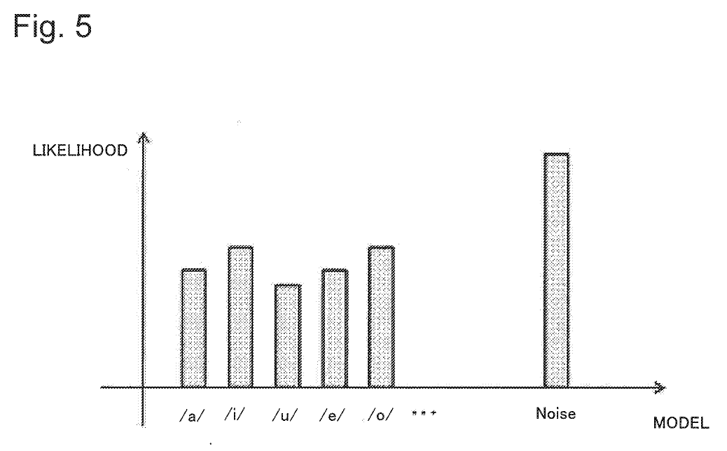

FIG. 5 is a diagram illustrating a specific example of the likelihood of a voice model and a non-voice model in a noise section including noise learned as a non-voice model. As illustrated, in the learned noise section, the likelihood of the non-voice model is large, and therefore the voice-to-non-voice likelihood ratio is small. Consequently, the speech detection device 10 according to the first exemplary embodiment is able to correctly determine the section as non-voice, in accordance with the likelihood ratio.

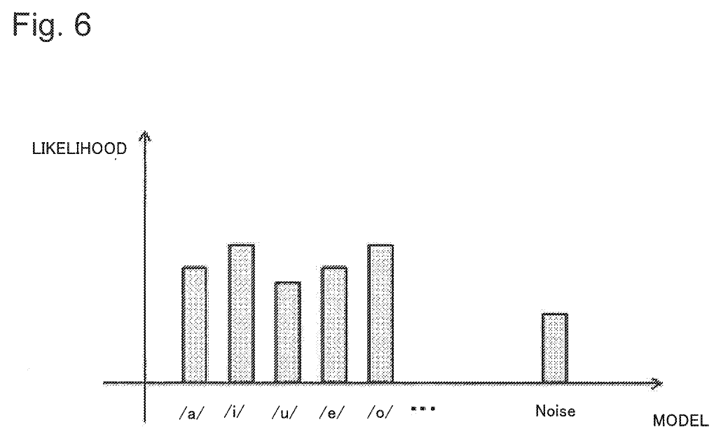

FIG. 6 is a diagram illustrating a specific example of the likelihood of a voice model and a non-voice model in a noise section including noise not learned as a non-voice model. As illustrated, in the unlearned noise section, the likelihood of the non-voice model is small, and therefore the voice-to-non-voice likelihood ratio is not sufficiently small, and, in some cases, may have a considerably large value. Consequently, the unlearned noise section is erroneously determined as voice, in accordance with the likelihood ratio

However, as illustrated in FIGS. 5 and 6, in a noise section, the posterior probability of any specific phoneme does not have an outstandingly large value, and the posterior probability is dispersed over a plurality of phonemes. In other words, the entropy of phoneme posterior probability is large. By contrast, as illustrated in FIG. 4, in a voice section, the posterior probability of a specific phoneme has an outstandingly large value. In other words, the entropy of phoneme posterior probability is small. By taking advantage of this feature, the speech detection device 10 according to the first exemplary embodiment is able to distinguish between voice and non-voice.

The present inventors discovered that, in order to correctly classify voice and non-voice, in accordance with the entropy and the time difference of phoneme posterior probability, averaging of the entropy and the time difference for a time length of at least several hundreds of milliseconds is required. In order to make the most of such a property, the speech detection device 10 according to the first exemplary embodiment first determines a candidate target voice section by use of a likelihood ratio, in accordance with the voice section detection unit 20. The speech detection device 10 according to the first exemplary embodiment has a processing configuration that subsequently determines, for each of a plurality of candidate target voice sections separated from one another existing in an acoustic signal, whether or not the candidate voice target section is a target voice section by use of at least one of the entropy and the time difference of phoneme posterior probability. Therefore, the speech detection device 10 according to the first exemplary embodiment is able to detect a target voice section with high precision even in an environment in which various types of noise exist.

### Modified Example 1 of First Exemplary Embodiment

The time difference calculation unit 262 may calculate the time difference of phoneme posterior probability by use of equation 5.

$$D ( t ) = {\sum }_{k} {\{ p ( {q}_{k} \vert {x}_{t} ) - p ( {q}_{k} \vert {x}_{t - n} ) \}}^{2} \qquad [ Equation 5 ]$$

Note that n denotes a frame interval for calculating the time difference and is preferably set to a value close to a typical phoneme interval in voice. For example, assuming that a phoneme interval is approximately 100 msec and a frame shift length is 10 msec, the time difference calculation unit 262 may set n=10. The present modified example causes the time difference of phoneme posterior probability in a voice section to have a larger value and increases precision of distinction between voice and non-voice.

### Modified Example 2 of First Exemplary Embodiment

When processing an acoustic signal input in real time to detect a voice section, the rejection unit 27 may, in a state that the section determination unit 24 determines only a starting end of a candidate target voice section, treat an entire frame section input after the starting end as a candidate target voice section and determine whether the candidate target voice section is voice or non-voice. Then, when determining the candidate target voice section as voice, the rejection unit 27 outputs the candidate target voice section as a voice detection result with only the starting end being determined. The present modified example is able to start processing in which the processing starts after a starting end of a voice section is detected, such as speech recognition, at an early timing before a finishing end is determined, while suppressing erroneous detection of a voice section.

It is preferred that the rejection unit 27 according to the present modified example starts determining whether a candidate target voice section is voice or non-voice after a certain amount of time such as several hundreds of milliseconds elapses after the section determination unit 24 determines a starting end of a voice section. The reason is that at least several hundreds of milliseconds are required in order to determine voice and non-voice with high precision, in accordance with the entropy and the time difference of phoneme posterior probability.

### Modified Example 3 of First Exemplary Embodiment

The posterior probability calculation unit 25 may performs a process of calculating the posterior probability only for a candidate target voice section determined by the section determination unit 24. In this case, the posterior-probability-based feature calculation unit 26 calculates at least one of the entropy and the time difference of phoneme posterior probability for only a candidate target voice section. The present modified example operates the posterior probability calculation unit 25 and the posterior-probability-based feature calculation unit 26 only for a candidate target voice section, and therefore is able to greatly reduce a calculation amount. The rejection unit 27 determines whether a section determined as a candidate target voice section by the section determination unit 24 is voice or non-voice, and therefore the present modified example is able to reduce a calculation amount while outputting a same detection result.

### Second Exemplary Embodiment

A speech detection device 10 according to a second exemplary embodiment will be described below focusing on difference from the first exemplary embodiment. Content similar to the first exemplary embodiment is omitted as appropriate in the description below.

### Processing Configuration

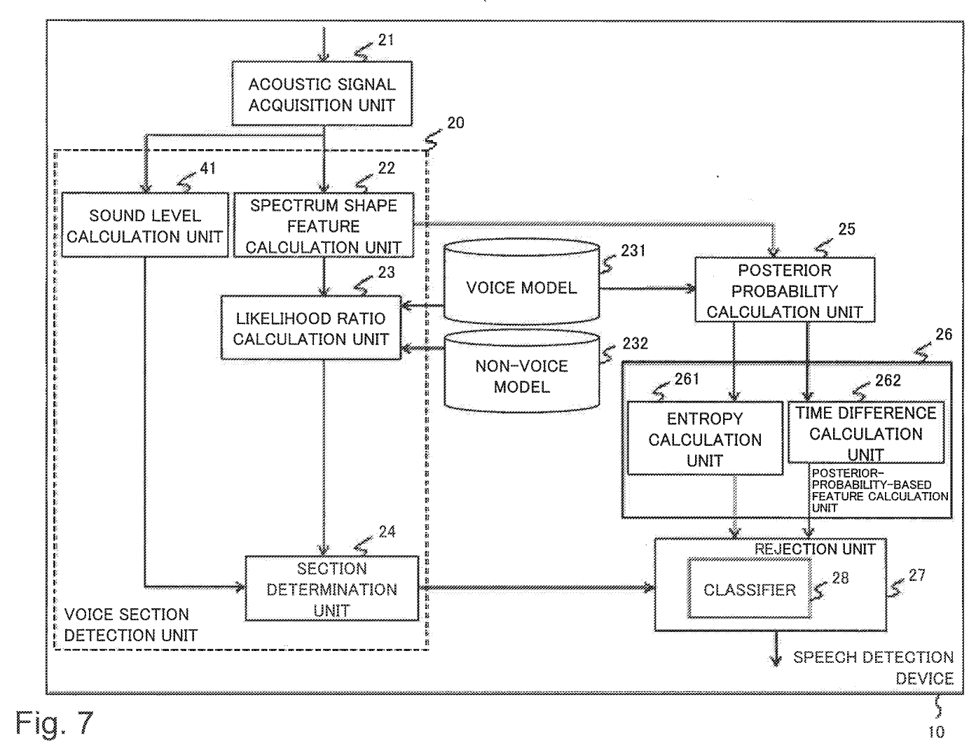

FIG. 7 is a diagram conceptually illustrating a processing configuration example of the speech detection device 10 according to the second exemplary embodiment. The speech detection device 10 according to the second exemplary embodiment further includes a sound level calculation unit 41 in addition to the first exemplary embodiment.

For each of a plurality of frames (second frames) extracted by the acoustic signal acquisition unit 21, the sound level calculation unit 41 performs a process of calculating a sound level of the second frame signal. The sound level calculation unit 41 may use an amplitude or power of the second frame signal, logarithmic values thereof, or the like as the sound level.

Alternatively, the sound level calculation unit 41 may take a ratio between a signal level and an estimated noise level in a second frame as the sound level of the signal. For example, the sound level calculation unit 41 may take a ratio between signal power and estimated noise power as the sound level of the second frame. By use of a ratio to an estimated noise level, the sound level calculation unit 41 is able to calculate a sound level robustly to variation of a microphone input level and the like. For estimation of a noise component in a second frame, the sound level calculation unit 41 may use, for example, a known technology such as PTL 1.

The acoustic signal acquisition unit 21 may extract a second frame processed by the sound level calculation unit 41 and a first frame processed by the spectrum shape feature calculation unit 22 with a same frame length and a same frame shift length. Alternatively, the acoustic signal acquisition unit 21 may separately extract a first frame and a second frame by use of a different value for at least one of a frame length and a frame shift length. For example, the acoustic signal acquisition unit 21 may extract a second frame by use of 100 msec as a frame length and 20 msec as a frame shift length, and extract a first frame by use of 30 msec as a frame length and 10 msec as a frame shift length. Thus, the acoustic signal acquisition unit 21 is able to use an optimum frame length and frame shift length for the sound level calculation unit 41 and the spectrum shape feature calculation unit 22, respectively.

The section determination unit 24 detects a candidate target voice section by use of a likelihood ratio calculated by the likelihood ratio calculation unit 23 and a sound level calculated by the sound level calculation unit 41. An example of the detection method will be described below.

First, the section determination unit 24 creates a pair of a first frame and a second frame. When frame lengths and frame shift lengths of a first frame and a second frame are the same, the section determination unit 24 pairs a first frame with a second frame extracting a same position in an acoustic signal. When at least one of frame lengths and frame shift lengths are different between a first frame and a second frame, the section determination unit 24 specifies a section corresponding to a first frame and a section corresponding to a second frame by use of an elapsed time from the start point of the acoustic signal, taking advantage of the technique described in the first exemplary embodiment and the like. Then, the section determination unit 24 pairs a first frame with a second frame having a same elapsed time. When same pairs appear in a plurality of elapsed times, they may be treated as one pair. Further, one first frame may be paired with two or more different second frames. Similarly, one second frame may be paired with two or more different first frames.

After creating a pair, the section determination unit 24 performs the following processing for each pair. For example, where fL denotes a likelihood ratio in a first frame and fP denotes a sound level in a second frame, the section determination unit 24 calculates a score S by use of equation 6 as a weighted sum of the two. Then, the section determination unit 24 determines a pair having a score S greater than or equal to a predetermined threshold value as a pair including target voice, and determines a pair having a score S less than the threshold value not as a pair including target voice (determines as a pair not including target voice). The section determination unit 24 determines a section corresponding to a pair including target voice as a candidate target voice section, and determines a section corresponding to a pair not including target voice not as a candidate target voice section. A section corresponding to each pair is specified/expressed by frame identification information, an elapsed time from the start point of an acoustic signal, or the like.

S=w_{L}·f_{L}+wₚ·fₚ [Equation 6]

Note that wL and wP denote weights. The two weights may be used development data, for example, be learned with a minimum error criterion of voice and non-voice or the like, or be set empirically.

As another method of detecting a voice section by use of a likelihood ratio and a sound level, the section determination unit 24 may classify whether each frame is voice or non-voice by use of the classifier 28 having a likelihood ratio and a sound level as features. The section determination unit 24 may use a GMM, logistic regression, a support vector machine, or the like as the classifier 28. The section determination unit 24 may use an acoustic signal labeled with voice or non-voice as learning data for the classifier 28.

### Operation Example

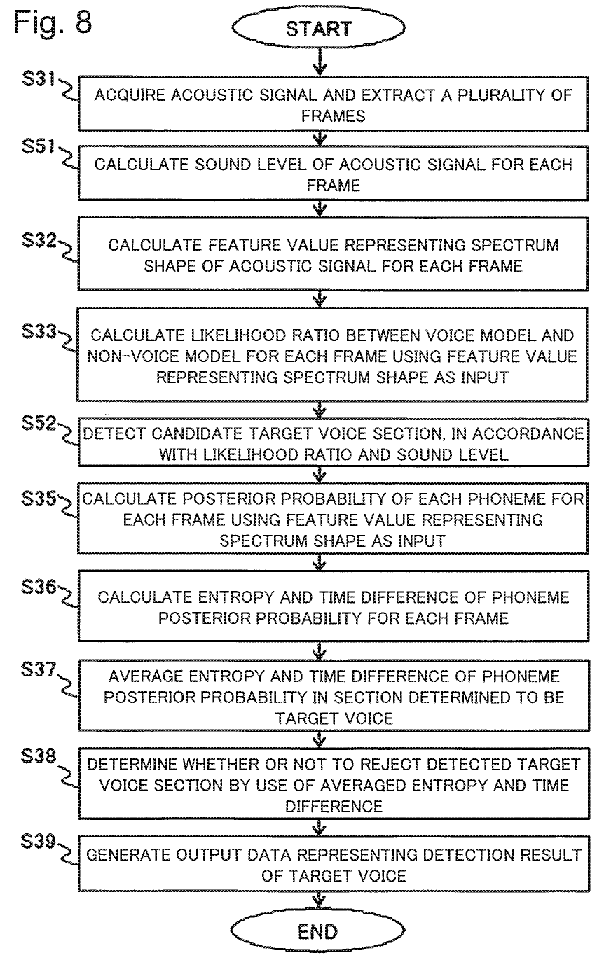

A speech detection method according to the second exemplary embodiment will be described below by use of FIG. 8. FIG. 8 is a flowchart illustrating an operation example of the speech detection device 10 according to the second exemplary embodiment. In FIG. 8, a same reference sign as FIG. 3 is given to a same step indicated in FIG. 3. Description of a step described in a previous exemplary embodiment is omitted.

In S51, for each frame extracted in S31, the speech detection device 10 calculates a signal sound level of the frame.

In S52, the speech detection device 10 detects a candidate target voice section from the acoustic signal by use of the likelihood ratio calculated in S33 and the sound level calculated in S51.

### Operations and Effects of Second Exemplary Embodiment

As described above, the second exemplary embodiment performs detection of a candidate target voice section by use of a sound level of an acoustic signal in addition to a voice-to-non-voice likelihood ratio. Therefore, the second exemplary embodiment is able to determine a voice section with a certain degree of precision even in the presence of voice noise including human voice. Additionally, even in the presence of noise not learned as a non-voice model, the second exemplary embodiment is able to detect a target voice section with yet higher precision, without erroneously detecting such noise as voice.

None of the likelihood ratio, the entropy of phoneme posterior probability, and the time difference of phoneme posterior probability includes information related to a sound level of an acoustic signal. Consequently, the speech detection device 10 according to the first exemplary embodiment may erroneously detect voice noise having a low sound level as target voice. The speech detection device 10 according to the second exemplary embodiment detects target voice by additionally using a sound level, and therefore is able to detect a target voice section with high precision without erroneously detecting voice noise.

### Third Exemplary Embodiment

A speech detection device 10 according to a third exemplary embodiment will be described below focusing on difference from the second exemplary embodiment. Content similar to the second exemplary embodiment is omitted as appropriate in the description below.

### Processing Configuration

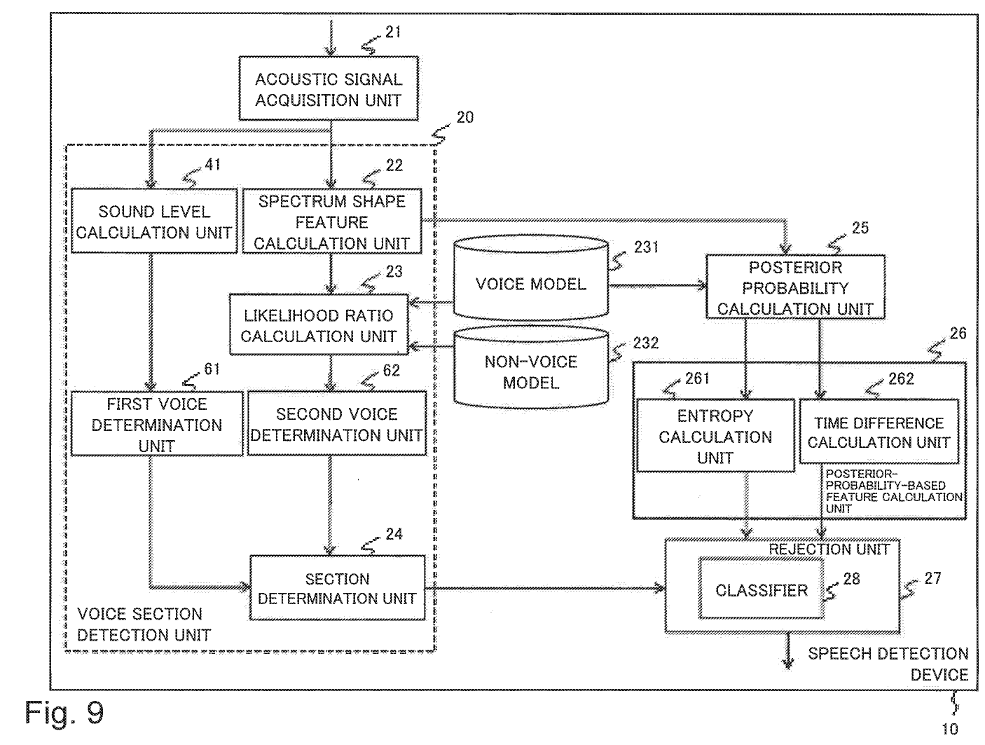

FIG. 9 is a diagram conceptually illustrating a processing configuration example of the speech detection device 10 according to the third exemplary embodiment. The speech detection device 10 according to the third exemplary embodiment further includes a first voice determination unit 61 and a second voice determination unit 62 in addition to the second exemplary embodiment.

The first voice determination unit 61 compares a sound level calculated by the sound level calculation unit 41 with a predetermined first threshold value for each second frame. Then, the first voice determination unit 61 determines a second frame having a sound level greater than or equal to the first threshold value as a second frame including target voice (hereinafter referred to as “second target frame”), and determines a second frame having a sound level less than the first threshold value as a second frame not including target voice (hereinafter referred to as “second non-target frame”). The first threshold value may be determined by use of an acoustic signal being a processing target. For example, the first voice determination unit 61 may calculate respective sound levels of a plurality of second frames extracted from an acoustic signal being a processing target, and take a value calculated in accordance with a predetermined operation using the calculation result (such as a mean value, a median value, or a boundary value separating the top X % from the bottom [100−X]%) as the first threshold value.

The second voice determination unit 62 compares a likelihood ratio calculated by the likelihood ratio calculation unit 23 with a predetermined second threshold value for each first frame. Then, the second voice determination unit 62 determines a first frame having a likelihood ratio greater than or equal to the second threshold value as a first frame including target voice (first target frame), and determines a first frame having a sound level less than the second threshold value as a first frame not including target voice (first non-target frame).

The section determination unit 24 determines a section included in both a first target section corresponding to a first target frame in an acoustic signal and a second target section corresponding to a second target frame as a candidate target voice section. In other words, the section determination unit 24 determines a section determined to include target voice by both the first voice determination unit 61 and the second voice determination unit 62 as a candidate target voice section.

The section determination unit 24 specifies a section corresponding to a first target frame and a section corresponding to a second target frame by a mutually comparable expression (criterion). Then, the section determination unit 24 specifies a target voice section included in both.

For example, when frame lengths and frame shift lengths of a first frame and a second frame are the same, the section determination unit 24 may specify a first target section and a second target section by use of identification information of a frame. In this case, for example, first target sections are expressed by frame numbers 6 to 9, 12 to 19, . . . , and second target sections are expressed by frame numbers 5 to 7, 11 to 19, . . . . Then, the section determination unit 24 specifies a frame included in both a first target section and a second target section as a candidate target voice section. When first target sections and second target sections are expressed by the example above, the candidate target voice sections are expressed by frame numbers 6 and 7, 12 to 19, . . . .

Additionally, the section determination unit 24 may specify a section corresponding to a first target frame and a section corresponding to a second target frame by use of an elapsed time from the start point of an acoustic signal. In this case, for example, the section determination unit 24 expresses sections respectively corresponding to a first target frame and a second target frame by an elapsed time from the start point of the acoustic signal by use of the technique described in the first exemplary embodiment. Then, the section determination unit 24 specifies a time period included in both as a candidate target voice section.

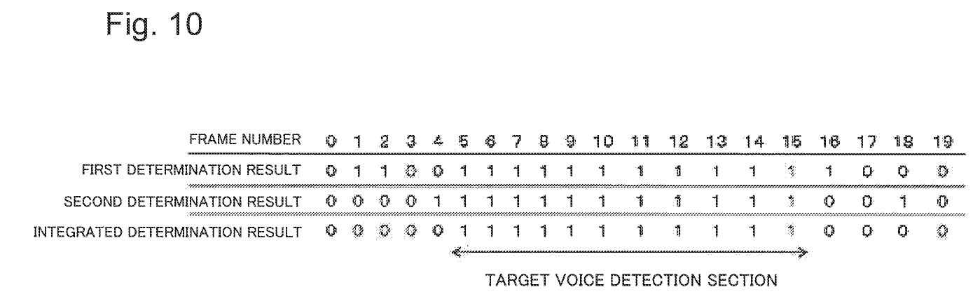

An example of processing in the section determination unit 24 will be described by use of FIG. 10. In the case of the example in FIG. 10, a first frame and a second frame are extracted with a same frame length and a frame shift length. In FIG. 10, a frame determined to include target voice is represented by “1” and a frame determined not to include target voice (non-voice) is represented by “0.” In the drawing, a “first determination result” represents a determination result of the first voice determination unit 61 and a “second determination result” represents a determination result of the second voice determination unit 62. Further, an “integrated determination result” represents a determination result of the section determination unit 24. As can be seen from the drawing, the section determination unit 24 determines a section corresponding to frames for which both first determination results based on the first voice determination unit 62 and second determination results based on the second voice determination unit 62 are “1,” that is, frames having frame numbers 5 to 15, as a candidate target voice section.

### Operation Example

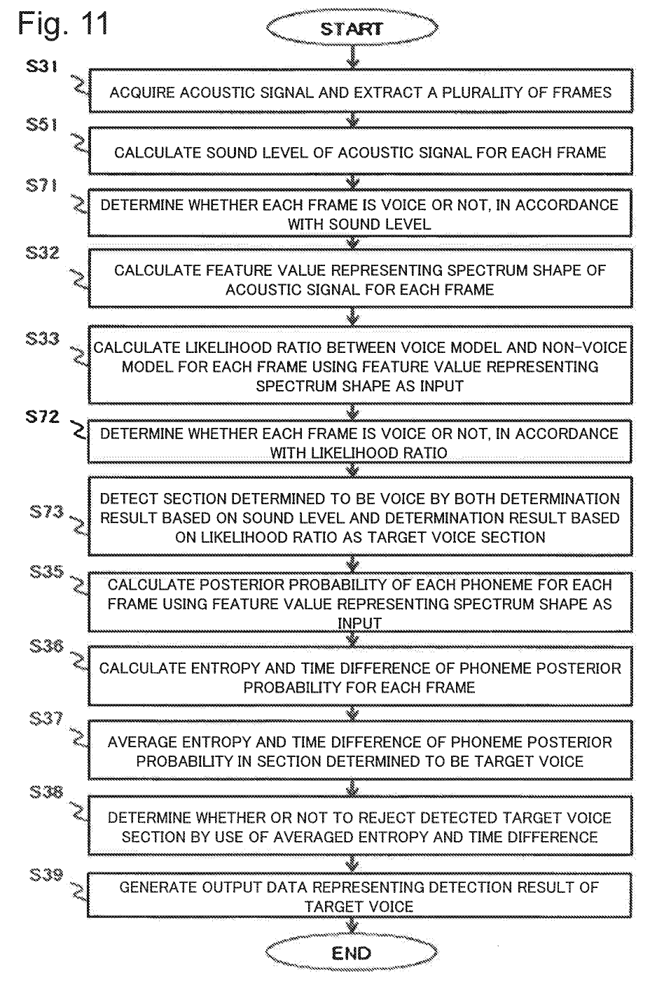

A speech detection method according to the third exemplary embodiment will be described below by use of FIG. 11. FIG. 11 is a flowchart illustrating an operation example of the speech detection device 10 according to the third exemplary embodiment. In FIG. 11, a same reference sign as FIG. 8 is given to a same step indicated in FIG. 8. Description of a step described in a previous exemplary embodiment is omitted.

In S71, the speech detection device 10 compares the sound level calculated in S51 with a predetermined first threshold value. Then, the speech detection device 10 determines a second frame having a sound level greater than or equal to the first threshold value as a second target frame including target voice, and determines a second frame having a sound level less than the first threshold value as a second non-target frame not including target voice.

In S72, the speech detection device 10 compares the likelihood ratio calculated in S33 with a predetermined second threshold value. Then, the speech detection device 10 determines a first frame having a likelihood ratio greater than or equal to the second threshold value as a first target frame including target voice, and determines a first frame having a likelihood ratio less than the second threshold value as a first non-target frame not including target voice.

In S73, the speech detection device 10 determines a section included in both a section corresponding to the first target frame determined in S71 and a section corresponding to the second target frame determined in S72 as a candidate target voice section.

The operation of the speech detection device 10 is not limited to the operation example in FIG. 11. For example, a set of processing steps in S51 to S71 and a set of processing steps in S32 to S72 may be performed in a reverse order. These sets of processing steps may be performed simultaneously in parallel by use of a plurality of CPUs. Further, in a case of processing an acoustic signal input in real time or the like, the speech detection device 10 may perform each of the processing steps in S31 to S73 repeatedly on a frame-by-frame basis. For example, the speech detection device 10 may operate to extract a single frame from an input acoustic signal in S31, process only the extracted single frame in S51 to S71 and S32 to S72, process only a frame for which determination is complete in S71 and S72 in S73, and repeatedly perform S31 to S73 until processing of the entire input acoustic signal is complete.

[Operations and Effects of Third Exemplary Embodiment] As described above, the third exemplary embodiment detects a section having a sound level greater than or equal to a predetermined threshold value and also having a likelihood ratio between a voice model and a non-voice model, with a feature value representing a frequency spectrum shape as an input, greater than or equal to a predetermined threshold value as a candidate target voice section. Therefore, the third exemplary embodiment is able to correctly determine a voice section even in an environment in which various types of noise exist simultaneously. Additionally, even in the presence of noise not learned as a non-voice model, the third exemplary embodiment is able to detect a target voice section with yet higher precision without erroneously detecting such noise as voice.

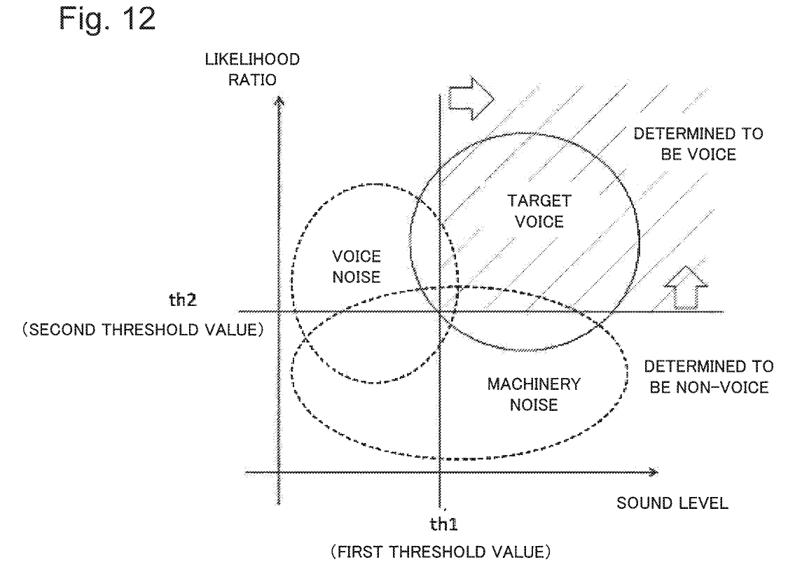

FIG. 12 is a diagram illustrating an effect that the speech detection device 10 according to the third exemplary embodiment is able to correctly detect target voice even when various types of noise exist simultaneously. FIG. 12 is a diagram arranging target voice to be detected and noise not to be detected in a space expressed by two axes being “sound level” and “voice-to-non-voice likelihood ratio.” “Target voice” to be detected is generated at a location close to a microphone and therefore has a high sound level, and, in addition, is human voice and therefore has a high likelihood ratio.

As a result of analyzing background noise in various situations to which a voice detection technology is applied, the present inventors discovered that various types of noise can be roughly classified into two types being “voice noise” and “machinery noise,” and both noise types are distributed in an L shape in a “sound level”-and-“likelihood ratio” space as illustrated in FIG. 12.

As described above, voice noise is noise including human voice. Voice noise includes, for example, voice in a conversation by people around, announcement voice in station premises and voice generated by a TV. In most of situations to which a voice detection technology is applied, these types of voice are not preferred to be detected. Voice noise is human voice, and therefore the voice-to-non-voice likelihood ratio is high. Consequently, the likelihood ratio is not able to distinguish between voice noise and target voice to be detected. By contrast, voice noise is generated at a location distant from a microphone, and therefore the sound level is low. In FIG. 12, voice noise largely exists in a domain in which the sound level is less than a first threshold value th1. Consequently, voice noise may be rejected by determining a signal as voice when the sound level is greater than or equal to the first threshold value.

Machinery noise is noise not including human voice. Machinery noise includes, for example, a road work sound, a car traveling sound, a door-opening/closing sound, and a keying sound. The sound level of machinery noise may be high or low and, in some cases, equal to or higher than target voice to be detected. Thus, machinery noise and target voice cannot be distinguished by sound level. Meanwhile, when machinery noise is properly learned as a non-voice model, the voice-to-non-voice likelihood ratio of machinery noise is low. In FIG. 12, machinery noise largely exists in a domain in which the likelihood ratio is less than a second threshold value th2. Consequently, machinery noise may be rejected by determining a signal as voice when the likelihood ratio is greater than or equal to the predetermined second threshold value.

In the speech detection device 10 according to the third exemplary embodiment, the sound level calculation unit 41 and the first voice determination unit 61 operate to reject noise having a low sound level, that is, voice noise. Further, the spectrum shape feature calculation unit 22, the likelihood ratio calculation unit 23, and the second voice determination unit 62 operate to reject noise having a low likelihood ratio, that is, machinery noise. Then, the section determination unit 24 detects a section determined as target voice by both the first voice determination unit 61 and the second voice determination unit 62 as a candidate target voice section. Therefore, the speech detection device 10 according to the third exemplary embodiment is able to detect a candidate target voice section with high precision even in an environment in which voice noise and machinery noise exist simultaneously, without erroneously detecting both noises. Further, in the speech detection device 10 according to the third exemplary embodiment, the rejection unit 27 determines whether a detected candidate target voice section is truly voice or non-voice by use of at least one of the entropy and the time difference of phoneme posterior probability. By having such a configuration, the speech detection device 10 according to the third exemplary embodiment is able to detect a target voice section with high precision even in the presence of any noise type of voice noise, machinery noise, and noise not learned as a non-voice model.

### Fourth Exemplary Embodiment

A speech detection device 10 according to a fourth exemplary embodiment will be described below focusing on difference from the third exemplary embodiment. Content similar to the third exemplary embodiment is omitted as appropriate in the description below.

### Processing Configuration

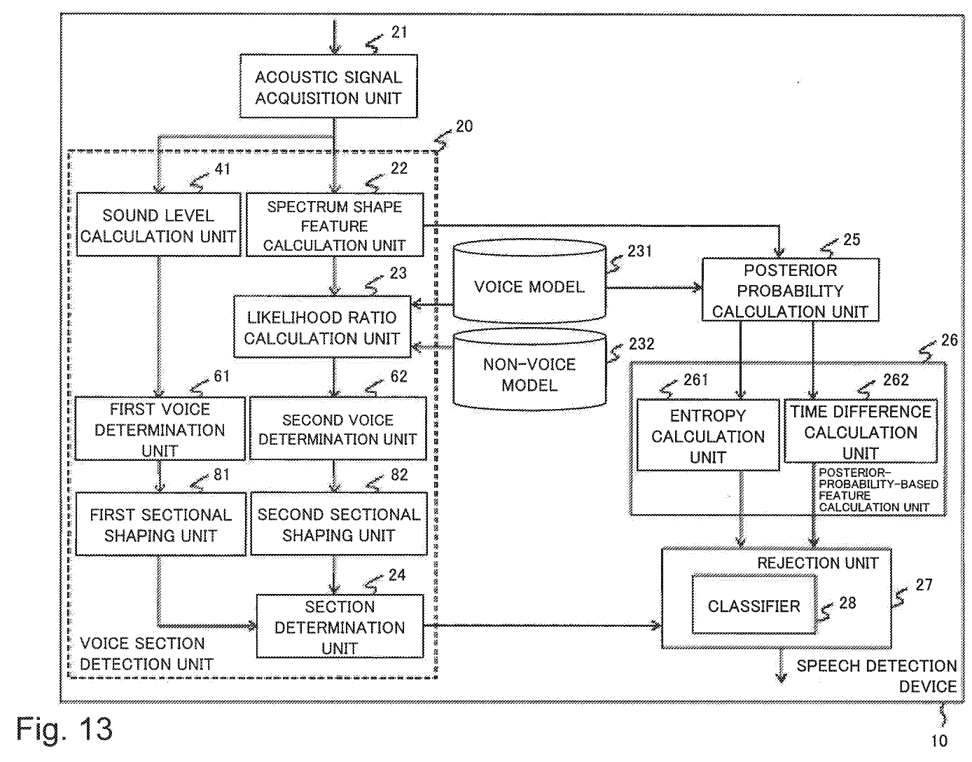

FIG. 13 is a diagram conceptually illustrating a processing configuration example of the speech detection device 10 according to the fourth exemplary embodiment. The speech detection device 10 according to the fourth exemplary embodiment further includes a first sectional shaping unit 81 and a second sectional shaping unit 82 in addition to the configuration of the third exemplary embodiment.

The first sectional shaping unit 81 determines whether each frame is voice or not by performing a shaping process on a determination result of the first voice determination unit 61 to eliminate a target voice section shorter than a predetermined value and a non-target voice section shorter than a predetermined value.

For example, the first sectional shaping unit 81 performs at least one of the following two types of shaping processes on a determination result of the first voice determination unit 61. Then, after performing the shaping process, the first sectional shaping unit 81 inputs the determination result after the shaping process to the section determination unit 24.

“A shaping process of, out of a plurality of second target sections (sections corresponding to second target frames determined to include target voice by the first voice determination unit 61) separated from one another in an acoustic signal, changing a second target frame corresponding to a second target section having a length less than a predetermined value to a second frame not being a second target frame.”

“A shaping process of, out of a plurality of second non-target sections (sections corresponding to second target frames determined not to include target voice by the first voice determination unit 61) separated from one another in an acoustic signal, changing a second frame corresponding to a second non-target section having a length less than a predetermined value to a second target frame.”

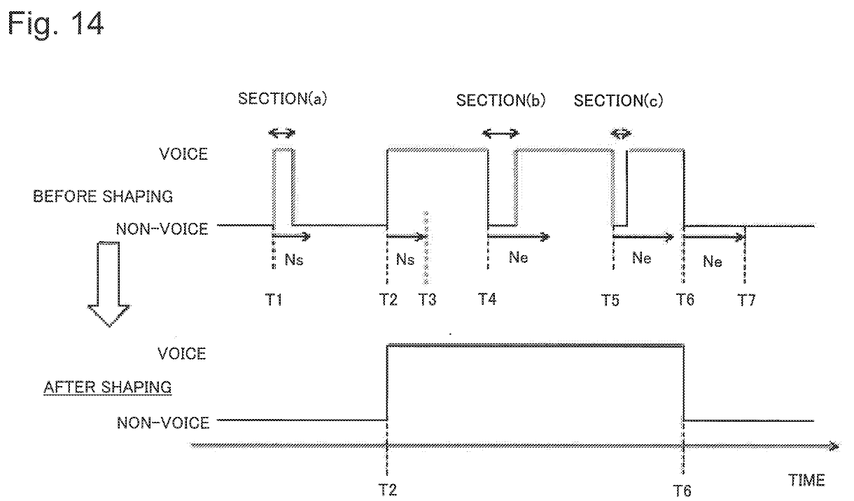

FIG. 14 is a diagram illustrating a specific example of a shaping process of changing a second target section having a length less than Ns sec to a second non-target section and a shaping process of changing a second non-target section having a length less than Ne sec to a second target section, respectively performed by the first sectional shaping unit 81. The length may be measured in a unit other than seconds such as a number of frames.

The upper row in FIG. 14 illustrates a voice detection result before shaping, that is, an output of the first voice determination unit 61. The lower row in FIG. 14 illustrates a voice detection result after shaping. The upper row in FIG. 14 illustrates that target voice is determined to be included at a time T1. However, the length of a section (a) determined to continuously include target voice is less than Ns sec. Therefore, the second target section (a) is changed to a second non-target section (refer to the lower row in FIG. 14). Meanwhile, the upper row in FIG. 14 illustrates that a second target section starting at a time T2 has a length greater than or equal to Ns sec, and therefore is not changed to a second non-target section, and remains as a second target section (refer to the lower row in FIG. 14). In other words, the first voice determination unit 61 determines the time T2 as a starting end of a voice detection section (second target section) at a time T3.

Further, while the upper row in FIG. 14 illustrates determination of non-voice at a time T4, a length of a section (b) determined as continuously non-voice is less than Ne sec. Therefore, the second non-target section (b) is changed to a second target section (refer to the lower row in FIG. 14). Further, the upper row in FIG. 14 illustrates a length of a second non-target section (c) starting at a time T5 is also less than Ne sec. Therefore, the second non-target section (c) is also changed to a second target section (refer to the lower row in FIG. 14). Meanwhile, the upper row in FIG. 14 illustrates that a second non-target section starting at a time T6 has a length greater than or equal to Ne sec, and therefore is not changed to a second target section, and remains as a second non-target section (refer to the lower row in FIG. 14). In other words, the first voice determination unit 61 determines the time T6 as a finishing end of the voice detection section (second target section) at a time T7.

The parameters Ns and Ne are preset to appropriate values, in accordance with an evaluation experiment or the like using development data.

The voice detection result in the upper row in FIG. 14 is shaped to the voice detection result in the lower row, in accordance with the shaping process described above. The shaping process of a voice detection section is not limited to the procedures described above. For example, processing of eliminating a voice section having a length less than or equal to a certain length on a section obtained through the procedures described above may be added to the shaping process, or another method may be used for shaping a voice detection section.

The second sectional shaping unit 82 determines whether each frame is voice or not by performing a shaping process on a determination result of the second voice determination unit 62 to eliminate a voice section shorter than a predetermined value and a non-voice section shorter than a predetermined value.

For example, the second sectional shaping unit 82 performs at least one of the following two types of shaping processes on a determination result of the second voice determination unit 62. Then, after performing the shaping process, the second sectional shaping unit 82 inputs the determination result after the shaping process to the section determination unit 24.

“A shaping process of, out of a plurality of first target sections (sections corresponding to first target frames determined to include target voice by the second voice determination unit 62) separated from one another in an acoustic signal, changing a first target frame corresponding to a first target section having a length shorter than a predetermined value to a first frame not being a first target frame.”

“A shaping process of, out of a plurality of first non-target sections (sections corresponding to first target frames determined not to include target voice by the second voice determination unit 62) separated from one another in an acoustic signal, changing a first frame corresponding to a first non-target section having a length shorter than a predetermined value to a first target frame.”

Processing details of the second sectional shaping unit 82 are the same as the first sectional shaping unit 81 except that an input is a determination result of the second voice determination unit 62 instead of a determination result of the first voice determination unit 61. Parameters used for shaping, such as Ns and Ne in the example in FIG. 14, may be different between the first sectional shaping unit 81 and the second sectional shaping unit 82.

The section determination unit 24 specifies a candidate target voice section by use of determination results after the shaping process input from the first sectional shaping unit 81 and the second sectional shaping unit 82. Specifically, the section determination unit 24 determines a section determined to include target voice by both the first sectional shaping unit 81 and the second sectional shaping unit 82 as a candidate target voice section. Processing details of the section determination unit 24 according to the present exemplary embodiment are the same as the section determination unit 24 according to the third exemplary embodiment except that inputs are determination results of the first sectional shaping unit 81 and the second sectional shaping unit 82 instead of determination results of the first voice determination unit 61 and the second voice determination unit 62.

The speech detection device 10 according to the fourth exemplary embodiment may output a section determined as candidate target voice by the section determination unit 24 as a voice detection result.

### Operation Example

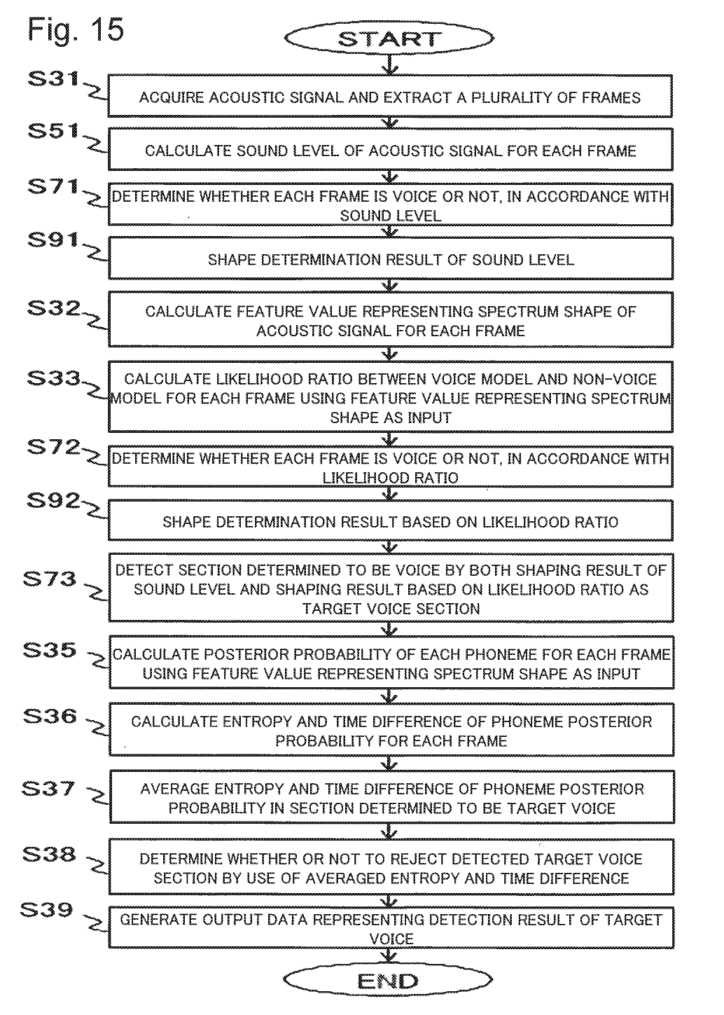

A speech detection method according to the fourth exemplary embodiment will be described below by use of FIG. 15. FIG. 15 is a flowchart illustrating an operation example of the speech detection device according to the fourth exemplary embodiment. In FIG. 15, a same reference sign as FIG. 11 is given to a same step indicated in FIG. 11. Description of a step described in a previous exemplary embodiment is omitted.

In S91, the speech detection device 10 determines whether each frame is voice or not by performing a shaping process on a determination result of sound level in S71

In S92, the speech detection device 10 determines whether each frame is voice or not by performing a shaping process on a determination result of likelihood ratio in S72.

In S73, the speech detection device 10 determines a section determined as voice in both S91 and S92 as a candidate target voice section.

The operation of the speech detection device 10 is not limited to the operation example in FIG. 15. For example, a set of processing steps in S51 to S91 and a set of processing steps in S32 to S92 may be performed in a reverse order. These sets of processing may be performed simultaneously in parallel by use of a plurality of CPUs. Further, in a case of processing an acoustic signal input in real time or the like, the speech detection device 10 may perform each of the processing steps in S31 to S73 repeatedly on a frame-by-frame basis. In this case, in order to determine whether a frame is voice or non-voice, the shaping process in S91 and S92 requires determination results in S71 and S72 with respect to several frames after the frame in question. Consequently, determination results in S91 and S92 are output with delay from real time by a number of frames required for determination. The speech detection device 10 may operate to perform S73 on a section for which determination results based on S91 and S92 are obtained.

### Operations and Effects of Fourth Exemplary Embodiment

As described above, the fourth exemplary embodiment performs a shaping process on a voice detection result of sound level, and also performs another type of shaping processes on a voice detection result of likelihood ratio, and subsequently detects a section determined as voice in both of the shaping results as a candidate target voice section. Therefore, the fourth exemplary embodiment is able to detect a target voice section with high precision even in an environment in which various types of noise exist simultaneously, and also is able to prevent a voice detection section from being fragmented due to a short gap such as breathing during an utterance.

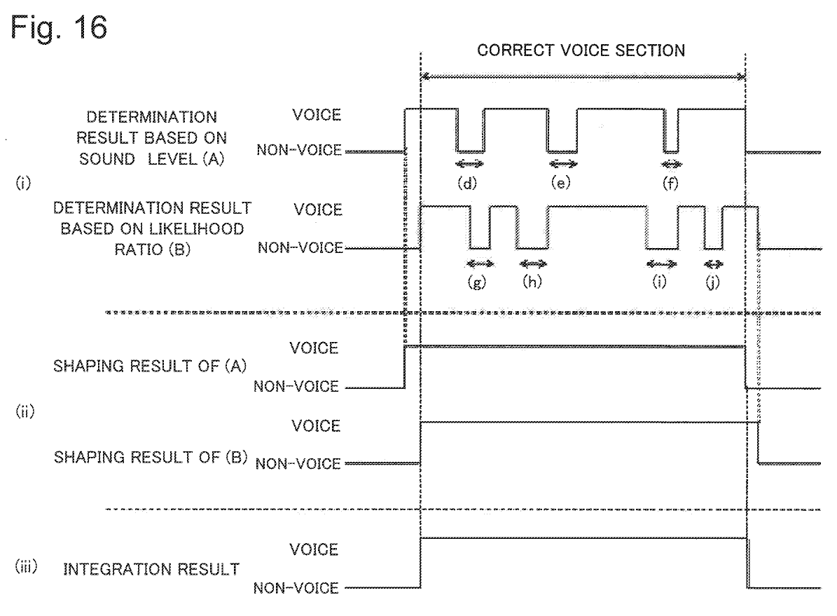

FIG. 16 is a diagram describing a mechanism that enables the speech detection device 10 according to the fourth exemplary embodiment to prevent a voice detection section from being fragmented. FIG. 16 is a diagram schematically illustrating outputs of the respective units in the speech detection device 10 according to the fourth exemplary embodiment when an utterance to be detected is input.

A “determination result of sound level (A)” in FIG. 16 illustrates a determination result of the first voice determination unit 61 and a “determination result of likelihood ratio (B)” illustrates a determination result of the second voice determination unit 62. As illustrated in the drawing, even in a continuous utterance, the determination result of on sound level (A) and the determination result of likelihood ratio (B) are often composed of a plurality of voice sections (first and second target sections) and non-voice sections (first and second non-target sections). For example, even in a continuous utterance, a sound level constantly fluctuates. A partial drop of several tens of milliseconds to several hundreds of milliseconds in sound level is often observed. Further, even in a continuous utterance, a partial drop of several tens of milliseconds to several hundreds of milliseconds in likelihood ratio at a phoneme boundary and the like is also often observed. Furthermore, a position of a section determined as target voice is mostly different between the determination result of sound level (A) and the determination result of likelihood ratio (B). The reason is that the sound level and the likelihood ratio respectively capture different features of an acoustic signal.

A “shaping result of (A)” in FIG. 16 illustrates a shaping result of the first sectional shaping unit 81, and a “shaping result of (B)” illustrates a shaping result of the second sectional shaping unit 82. In accordance with the shaping process, short non-voice sections (second non-target sections) (d) to (f) in the determination result of sound level and short non-voice sections (first non-target sections) (g) to (j) in the determination result of likelihood ratio are eliminated (changed to first and second target sections), and one voice detection section (first and second target section) is respectively obtained.

An “integration result” in FIG. 16 illustrates a determination result of the section determination unit 24. The first sectional shaping unit 81 and the second sectional shaping unit 82 eliminate (change to first and second target sections) short non-voice sections (first and second non-target sections), and therefore one utterance section is correctly detected as an integration result.

The speech detection device 10 according to the fourth exemplary embodiment operates as described above, and therefore prevents one utterance section to be detected from being fragmented.

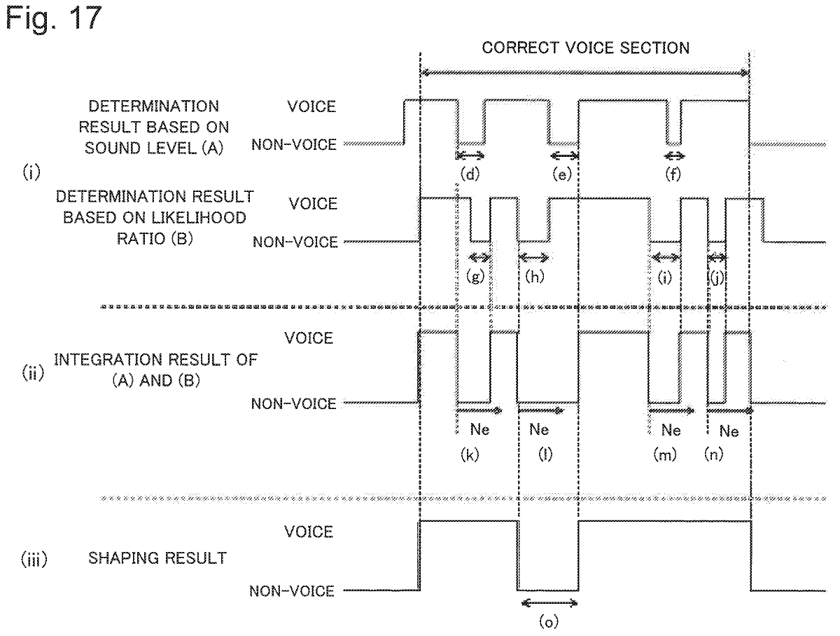

Such an effect is an effect obtained precisely because the device is so configured as to perform a sectional shaping process independently on a determination result of sound level and a determination result of likelihood ratio, respectively, and subsequently integrate the results. FIG. 17 is a diagram schematically illustrating outputs of the respective units when similar shaping process is performed on a candidate target voice section obtained by first applying the speech detection device 10 according to the third exemplary embodiment to the same input signal as FIG. 16. An “integration result of (A) and (B)” in FIG. 17 illustrates a determination result (candidate target voice section) of the section determination unit 24 according to the third exemplary embodiment, and a “shaping result” illustrates a result of performing a shaping process on the obtained determination result. As described above, a position of a section determined as voice is different between the determination result of voice (A) and the determination result of likelihood ratio (B). Consequently, a long non-voice section may appear in the integration result of (A) and (B). A section (1) in FIG. 17 represents such a long non-voice section. The length of the section (1) is longer than a parameter Ne of the shaping process, and therefore is not eliminated in accordance with the shaping process, and remains as a non-voice section (o). In other words, when a shaping process is performed on a result of the section determination unit 24, even in a continuous utterance section, a voice section to be detected tends to be fragmented.

Before integrating two types of determination results (a determination result of sound level and a determination result of likelihood ratio), the speech detection device 10 according to the fourth exemplary embodiment performs a sectional shaping process on the respective determination results, and therefore is able to detect a continuous utterance section as one voice section without fragmentation.

As described above, operation without interrupting a voice detection section in the middle of an utterance is particularly effective in a case such as applying speech recognition to a detected voice section. For example, in an apparatus operation using speech recognition, when a voice detection section is interrupted in the middle of an utterance, speech recognition cannot be performed on the entire utterance. Consequently, details of the apparatus operation cannot be correctly recognized. Further, in a spoken language, hesitation phenomena being interruption of an utterance occur frequently. When a detection section is fragmented by hesitations, precision of speech recognition tends to decrease.

Specific examples of voice detection under voice noise and machinery noise will be described below.

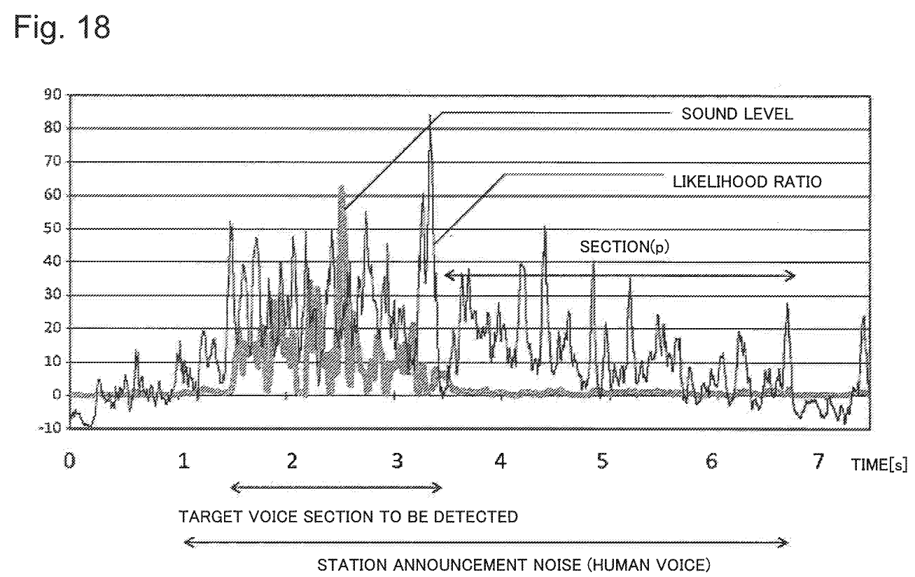

FIG. 18 illustrates a time series of a sound level and a likelihood ratio when a continuous utterance is performed under station announcement noise. A section from 1.4 to 3.4 sec represents a target voice section to be detected. The station announcement noise is voice noise. Therefore, a large value of the likelihood ratio continues in a section (p) after the utterance is complete. By contrast, the sound level in the section (p) has a small value. Therefore, the section (p) is correctly determined as non-voice by the speech detection device 10 according to the third and fourth exemplary embodiments. Additionally, in the target voice section to be detected (from 1.4 to 3.4 sec), the sound level and the likelihood ratio repeatedly fluctuate with varying magnitudes at varying positions. However, even in such a case, the speech detection device 10 according to the fourth exemplary embodiment is able to correctly detect the target voice section to be detected as one voice section without interrupting the utterance section.

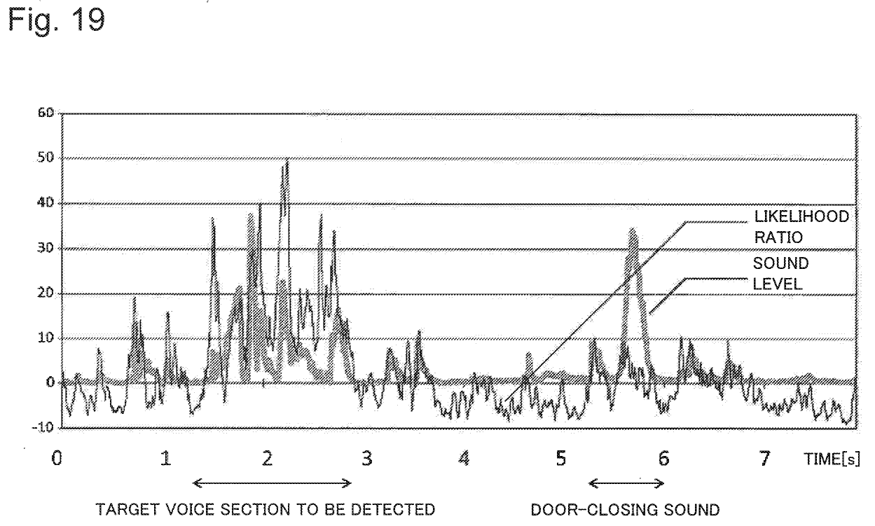

FIG. 19 illustrates a time series of a sound level and a likelihood ratio when a continuous utterance is performed in the presence of a door-closing sound (from 5.5 to 5.9 sec). A section from 1.3 to 2.9 sec is a target voice section to be detected. The door-closing sound is machinery noise and, in this case, the sound level of the door-closing sound has a higher value than the target voice section. By contrast, the likelihood ratio of the door-closing sound has a small value. Therefore, the door-closing sound is correctly determined as non-voice by the speech detection device 10 according to the third and fourth exemplary embodiments. Additionally, in the target voice section to be detected (from 1.3 to 2.9 sec), the sound level and the likelihood ratio repeatedly fluctuate with varying magnitudes at varying positions. However, even in such a case, the speech detection device 10 according to the fourth exemplary embodiment is able to correctly detect the target voice section to be detected as one voice section. Thus, the speech detection device 10 according to the fourth exemplary embodiment is confirmed to be effective in various real-world noise environments.

### Modified Example of Fourth Exemplary Embodiment

The spectrum shape feature calculation unit 22 may performs a process of calculating a feature value only for a section determined as target voice by the first sectional shaping unit 81 (second target section). In this case, the likelihood ratio calculation unit 23, the second voice determination unit 62, and the second sectional shaping unit 82 performs processes only on a frame for which the spectrum shape feature calculation unit 22 calculates a feature value (frame corresponding to a second target section).

In the present modified example, the spectrum shape feature calculation unit 22, the likelihood ratio calculation unit 23, the second voice determination unit 62, and the second sectional shaping unit 82 operate only on a section determined as target voice by the first sectional shaping unit 81 (second target section). Consequently, the present modified example is able to greatly reduce a calculation amount. The section determination unit 24 determines only a section determined as voice by the first sectional shaping unit 81 as a target voice section. Therefore, the present modified example is able to reduce a calculation amount while outputting a same detection result.

### Fifth Exemplary Embodiment

When the first, second, third, or fourth exemplary embodiment is configured by use of a program, a fifth exemplary embodiment is provided as a computer operating in accordance with the program.

### Processing Configuration

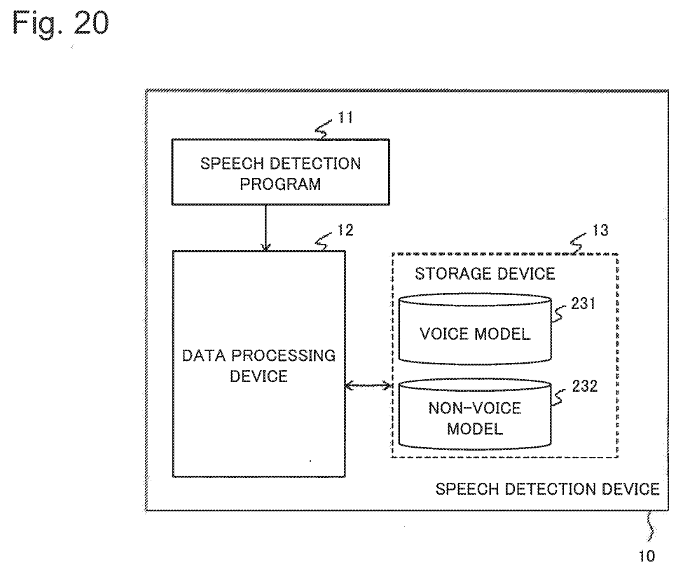

FIG. 20 is a diagram conceptually illustrating a processing configuration example of a speech detection device 10 according to the fifth exemplary embodiment. The speech detection device 10 according to the fifth exemplary embodiment includes a data processing device 12 including a CPU, a storage device 13 configured with a magnetic disk, a semiconductor memory, and the like, and a speech detection program 11, and the like. The storage device 13 stores a voice model 231, a non-voice model 232, and the like.

The speech detection program 11 implements a function according to the first, second, third, or fourth exemplary embodiment on the data processing device 12 by being read by the data processing device 12 and controlling an operation of the data processing device 12. In other words, the data processing device 12 performs processing of the acoustic signal acquisition unit 21, the spectrum shape feature calculation unit 22, the likelihood ratio calculation unit 23, the section determination unit 24, the posterior probability calculation unit 25, the posterior-probability-based feature calculation unit 26, the rejection unit 27, the sound level calculation unit 41, the first voice determination unit 61, the second voice determination unit 62, the first sectional shaping unit 81, the second sectional shaping unit 82, and the like, in accordance with control by the speech detection program 11.

The respective aforementioned exemplary embodiments and modified examples may be specified in part or in whole as the following Supplementary Notes. However, the respective exemplary embodiments and the modified examples are not limited to the following description.

Examples of reference exemplary embodiments are described below as Supplementary Notes.
1. A speech detection device includes:
acoustic signal acquisition means for acquiring an acoustic signal;
voice section detection means including
   spectrum shape feature calculation means for performing a process of calculating a feature value representing a spectrum shape for each of a plurality of first frames obtained from the acoustic signal,
   likelihood ratio calculation means for calculating a ratio of a likelihood of a voice model to a likelihood of a non-voice model for each of the plurality of first frames using the feature value as an input, and
   section determination means for determining a candidate target voice section that is a section including a target voice by use of the ratio of a likelihood of a voice model to a likelihood of a non-voice model;
posterior probability calculation means for performing a process of calculating a posterior probability of each of a plurality of phonemes using the feature value as an input;
posterior-probability-based feature calculation means for calculating at least one of entropy and time difference of posterior probabilities of the plurality of phonemes for each of the plurality of first frames; and
rejection means for specifying a section as changed to a section not including the target voice, out of the candidate target voice sections, by use of at least one of the entropy and the time difference of the posterior probabilities.
2. The speech detection device according to 1, wherein
the rejection means calculates an average value of at least one of the entropy and the time difference of the posterior probabilities for the candidate target voice section, and determines whether or not the candidate target voice section is a section not including the target voice by use of the average value.
3. The speech detection device according to 2, wherein
the rejection means determines the candidate target voice section meeting one or both of conditions as the section not including the target voice, the conditions being that:
the average value of the entropy is greater than a predetermined threshold value, and
the average value of the time difference is less than another predetermined threshold value.
4. The speech detection device according to 1, wherein
the rejection means specifies the section as changed to the section not including the target voice out of the candidate target voice sections by use of a classifier classifying sections into voice and non-voice, in accordance with at least one of the entropy and the time difference of the posterior probabilities, and
learning of the classifier is performed by use of a second learning acoustic signal in which each of a plurality of the candidate target voice sections is labeled as voice or non-voice, the candidate target voice sections being detected by the voice section detection means that performed a process for determining the candidate target voice section on a first learning acoustic signal.
5. The speech detection device according to any one of 1 to 4, wherein
the posterior probability calculation means performs a process of calculating the posterior probability only for the acoustic signal of the candidate target voice section.
6. The speech detection device according to any one of 1 to 5, wherein
the voice section detection means further includes:
sound level calculation means for performing a process of calculating a sound level for each of a plurality of second frames obtained from the acoustic signal, and
the section determination means determines the candidate target voice section by use of the ratio and the sound level.
7. The speech detection device according to 6, wherein
the voice section detection means further includes:
   first voice determination means for determining the second frame having the sound level greater than or equal to a first threshold value as a second target frame including the target voice, and
   second voice determination means for determining the first frame having the likelihood ratio greater than or equal to a second threshold value as a first target frame including the target voice, and wherein
the section determination means determines a section included in both a first target section corresponding to the first target frame and a second target section corresponding to the second target frame as the candidate target voice section.
8. The speech detection device according to 7 further includes:
first sectional shaping means for performing a shaping process on a determination result of the first voice determination means, and subsequently inputting the determination result after the shaping process to the section determination means; and
second sectional shaping means for performing a shaping process on a determination result of the second voice determination means, and subsequently inputting the determination result after the shaping process to the section determination means, wherein
the first sectional shaping means performs at least one of:
   a shaping process of changing the second target frame corresponding to the second target section having a length less than a predetermined value to the second frame not being the second target frame; and
   a shaping process of changing, out of second non-target sections that are not being the second target section, the second frame corresponding to a second non-target section having a length less than a predetermined value to the second target frame, and
the second sectional shaping means performs at least one of:
   a shaping process of changing the first target frame corresponding to the first target section having a length less than a predetermined value to the first frame that are not being the first target frame; and
   a shaping process of changing, out of the first non-target sections that are not being the first target section, the first frame corresponding to a first non-target section having a length less than a predetermined value to the first target frame.
9. A speech detection method performed by a computer, the method includes:
an acoustic signal acquisition step of acquiring an acoustic signal;
a voice section detection step including
   a spectrum shape feature calculation step of performing a process of calculating a feature value representing a spectrum shape for each of a plurality of first frames obtained from the acoustic signal,
   a likelihood ratio calculation step of calculating a ratio of a likelihood of a voice model to a likelihood of a non-voice model for each of the plurality of first frames using the feature value as an input, and
   a section determination step of determining a candidate target voice section that is a section including a target voice by use of the ratio of a likelihood of a voice model to a likelihood of a non-voice model;
a posterior probability calculation step of performing a process of calculating a posterior probability of each of a plurality of phonemes using the feature value as an input;
a posterior-probability-based feature calculation step of calculating at least one of entropy and time difference of posterior probabilities of the plurality of phonemes for each of the plurality of first frames; and
a rejection step of specifying a section to be changed to a section not including the target voice, out of the candidate target voice sections, by use of at least one of the entropy and the time difference of the posterior probabilities.
9-2. The speech detection method according to 9, wherein
in the rejection step, calculating an average value of at least one of the entropy and the time difference of the posterior probabilities for the candidate target voice section, and determining whether or not the candidate target voice section is a section not including the target voice by use of the average value.
9-3. The speech detection method according to 9-2, wherein
in the rejection step, determining the candidate target voice section meeting one or both of conditions as the section not including the target voice, the conditions being that:
the average value of the entropy is greater than a predetermined threshold value, and
the average value of the time difference is less than another predetermined threshold value.
9-4. The speech detection method according to 9-1, wherein
in the rejection step, specifying the section to be changed to the section not including the target voice out of the candidate target voice sections by use of a classifier classifying sections into voice and non-voice, in accordance with at least one of the entropy and the time difference of the posterior probabilities, and
learning of the classifier is performed by use of a second learning acoustic signal in that each of a plurality of the candidate target voice sections is labeled as voice or non-voice, the candidate target voice sections being detected by the voice section detection means performing a process for determining the candidate target voice section on a first learning acoustic signal.
9-5. The speech detection method according to any one of 9 to 9-4, wherein
in the posterior probability calculation step, performing a process of calculating the posterior probability only for the acoustic signal of the candidate target voice section.
9-6. The speech detection method according to any one of 1 to 5, wherein
the voice section detection step includes:
a sound level calculation step for performing a process of calculating a sound level for each of a plurality of second frames obtained from the acoustic signal, and
in the section determination step, determining the candidate target voice section by use of the likelihood ratio and the sound level.
9-7. The speech detection method according to 9-6, wherein
the voice section detection step includes:
   in the first voice determination step, determining the second frame having the sound level greater than or equal to a first threshold value as a second target frame including the target voice, and
   in the second voice determination step, determining the first frame having the likelihood ratio greater than or equal to a second threshold value as a first target frame including the target voice, and wherein
in the section determination step, determines a section included in both a first target section corresponding to the first target frame and a second target section corresponding to the second target frame as the candidate target voice section.
9-8. The speech detection method according to 9-7, further comprising:
a first sectional shaping step of performing a shaping process on a determination result of the first voice determination step, and subsequently inputting the determination result after the shaping process to the section determination step; and
a second sectional shaping step of performing a shaping process on a determination result of the second voice determination step, and subsequently inputting the determination result after the shaping process to the section determination step, wherein
in the first sectional shaping step, performing at least one of:
   a shaping process of changing the second target frame corresponding to the second target section having a length less than a predetermined value to the second frame not being the second target frame; and
   a shaping process of changing, out of second non-target sections that are not being the second target section, the second frame corresponding to a second non-target section having a length less than a predetermined value to the second target frame, and
in the second sectional shaping step, performing at least one of:
   a shaping process of changing the first target frame corresponding to the first target section having a length less than a predetermined value to the first frame not being the first target frame; and
   a shaping process of changing, out of first non-target sections that are not being the first target section, the first frame corresponding to a first non-target section having a length less than a predetermined value to the first target frame.
10. A program for causing a computer to function as:
acoustic signal acquisition means for acquiring an acoustic signal;
voice section detection means including
   spectrum shape feature calculation means for performing a process of calculating a feature value representing a spectrum shape for each of a plurality of first frames obtained from the acoustic signal,
   likelihood ratio calculation means for calculating a ratio of a likelihood of a voice model to a likelihood of a non-voice model for each of the plurality of first frames using the feature value as an input, and
   section determination means for determining a candidate target voice section that is a section including a target voice by use of the ratio of a likelihood of a voice model to a likelihood of a non-voice model;
posterior probability calculation means for performing a process of calculating a posterior probability of each of a plurality of phonemes using the feature value as an input;
posterior-probability-based feature calculation means for calculating at least one of entropy and time difference of posterior probabilities of the plurality of phonemes for each of the plurality of first frames; and
rejection means for specifying a section to be changed to a section not including the target voice, out of the candidate target voice sections, by use of at least one of the entropy and time the difference of the posterior probabilities.
10-2. The program according to 10, wherein
the rejection means calculates an average value of at least one of the entropy and the time difference of the posterior probabilities for the candidate target voice section, and determines whether or not the candidate target voice section is a section not including the target voice by use of the average value.
10-3. The program according to 10-2, wherein
the rejection means determines the candidate target voice section meeting at least one or both of conditions as the section not including the target voice, the conditions being that:
the average value of the entropy is greater than a predetermined threshold value, and
the average value of the time difference is less than another predetermined threshold value.
10-4. The program according to 10, wherein
the rejection means specifies the section to be changed to the section not including the target voice out of the candidate target voice sections by use of a classifier classifying sections into voice and non-voice, in accordance with at least one of the entropy and the time difference of the posterior probabilities, and
learning of the classifier is performed by use of a second learning acoustic signal in that each of a plurality of the candidate target voice sections is labeled as voice or non-voice, the candidate target voice sections being detected by the voice section detection means performing a process for determining the candidate target voice section on a first learning acoustic signal.
10-5. The program according to any one of 10 to 10-4, wherein
the posterior probability calculation means performs a process of calculating the posterior probability only for the acoustic signal of the candidate target voice section.
10-6. The program according to any one of 10 to 10-5, wherein
the voice section detection means further includes:
sound level calculation means for performing a process of calculating a sound level for each of a plurality of second frames obtained from the acoustic signal, and
the section determination means determines the candidate target voice section by use of the likelihood ratio and the sound level.
10-7. The program according to 10-6, wherein
the voice section detection means further includes:
   first voice determination means for determining the second frame having the sound level greater than or equal to a first threshold value as a second target frame including the target voice, and
   second voice determination means for determining the first frame having the likelihood ratio greater than or equal to a second threshold value as a first target frame including the target voice, and wherein
the section determination means determines a section included in both a first target section corresponding to the first target frame and a second target section corresponding to the second target frame as the candidate target voice section.
10-8. The program according to 10-7 further includes:
first sectional shaping means for performing a shaping process on a determination result of the first voice determination means, and subsequently inputting the determination result after the shaping process to the section determination means; and
second sectional shaping means for performing a shaping process on a determination result of the second voice determination means, and subsequently inputting the determination result after the shaping process to the section determination means, wherein
the first sectional shaping means performs at least one of:
   a shaping process of changing the second target frame corresponding to the second target section having a length less than a predetermined value to the second frame not being the second target frame; and
   a shaping process of changing, out of second non-target sections that are not being the second target section, the second frame corresponding to a second non-target section having a length less than a predetermined value to the second target frame, and
the second sectional shaping means performs at least one of:
   a shaping process of changing the first target frame corresponding to the first target section having a length less than a predetermined value to the first frame not being the first target frame; and
   a shaping process of changing, out of first non-target sections that are not being the first target section, the first frame corresponding to a first non-target section having a length less than a predetermined value to the first target frame.

This application is based upon and claims the benefit of priority from Japanese patent application No. 2013-218935, filed on Oct. 22, 2013, the disclosure of which is incorporated herein in its entirety by reference.

What is claimed is:

1. A speech detection device comprising:
an acoustic signal acquisition unit that acquires an acoustic signal;
a voice section detection unit including
a spectrum shape feature calculation unit that calculates a feature value representing a spectrum shape for each of a plurality of first frames obtained from the acoustic signal,
a likelihood ratio calculation unit that calculates a ratio of a likelihood of a voice model to a likelihood of a non-voice model for each of the plurality of first frames using the feature value as an input, and
a section determination unit that determines a candidate target voice section that is a section including a target voice by use of the ratio of a likelihood of a voice model to a likelihood of a non-voice model;
a posterior probability calculation unit that calculates a posterior probability of each of a plurality of phonemes using the feature value as an input;
a posterior-probability-based feature calculation unit that calculates at least one of entropy and time difference of posterior probabilities of the plurality of phonemes for each of the plurality of first frames; and
rejection unit that specifies a section to be changed to a section not including the target voice, out of the candidate target voice sections, by use of at least one of the entropy and the time difference of the posterior probabilities.

2. The speech detection device according to claim 1, wherein
the rejection unit calculates an average value of at least one of the entropy and the time difference of the posterior probabilities for the candidate target voice section, and determines whether or not the candidate target voice section is a section not including the target voice by use of the average value.

3. The speech detection device according to claim 2, wherein
the rejection unit determines the candidate target voice section meeting one or both of conditions as the section not including the target voice, the conditions being that:
the average value of the entropy is greater than a predetermined threshold value, and
the average value of the time difference is less than another predetermined threshold value.

4. The speech detection device according to claim 1, wherein
the rejection unit specifies the section to be changed to the section not including the target voice out of the candidate target voice sections by use of a classifier classifying sections into voice and non-voice, in accordance with at least one of the entropy and the time difference of the posterior probabilities, and
learning of the classifier is performed by use of a second learning acoustic signal in that each of a plurality of the candidate target voice sections is labeled as voice or non-voice, the candidate target voice sections being detected by the voice section detection that determines the candidate target voice section on a first learning acoustic signal.

5. The speech detection device according to claim 1, wherein
the posterior probability calculation unit calculates the posterior probability only for the acoustic signal of the candidate target voice section.

6. The speech detection device according to claim 1, wherein
the voice section detection unit further includes:
a sound level calculation unit that calculates a sound level for each of a plurality of second frames obtained from the acoustic signal, and
the section determination unit determines the candidate target voice section by use of the ratio and the sound level.

7. The speech detection device according to claim 6, wherein
the voice section detection unit further includes:
a first voice determination unit that determines the second frame having the sound level greater than or equal to a first threshold value as a second target frame including the target voice, and
a second voice determination unit that determines the first frame having the likelihood ratio greater than or equal to a second threshold value as a first target frame including the target voice, and wherein
the section determination unit determines a section included in both a first target section corresponding to the first target frame and a second target section corresponding to the second target frame as the candidate target voice section.

8. The speech detection device according to claim 7 further comprising:
a first sectional shaping unit that performs a shaping process on a determination result of the first voice determination unit, and subsequently inputs the determination result after the shaping process to the section determination unit; and
a second sectional shaping unit that performs a shaping process on a determination result of the second voice determination unit, and subsequently inputs the determination result after the shaping processing to the section determination unit, wherein
the first sectional shaping unit performs at least one of:
a shaping process of changing the second target frame corresponding to the second target section having a length less than a predetermined value to the second frame not being the second target frame; and
a shaping process of changing, out of second non-target sections that are not being the second target section, the second frame corresponding to a second non-target section having a length less than a predetermined value to the second target frame, and
the second sectional shaping unit performs at least one of:
a shaping process of changing the first target frame corresponding to the first target section having a length less than a predetermined value to the first frame not being the first target frame; and
a shaping process of changing, out of first non-target sections that are not being the first target section, the first frame corresponding to a first non-target section having a length less than a predetermined value to the first target frame.

9. A speech detection method performed by a computer, the method comprising:
acquiring an acoustic signal;
calculating a feature value representing a spectrum shape for each of a plurality of first frames obtained from the acoustic signal;
calculating a ratio of a likelihood of a voice model to a likelihood of a non-voice model for each of the plurality of first frames using the feature value as an input;
determining a candidate target voice section that is a section including a target voice by use of the ratio of a likelihood of a voice model to a likelihood of a non-voice model;
calculating a posterior probability of each of a plurality of phonemes using the feature value as an input;
calculating at least one of entropy and time difference of posterior probabilities of the plurality of phonemes for each of the plurality of first frames; and
specifying a section to be changed to a section not including the target voice, out of the candidate target voice sections, by use of at least one of the entropy and the time difference of the posterior probabilities.

10. A computer readable non-transitory medium having a computer readable program recorded thereon, wherein the computer readable program, when executed on a computing device, causes the computing device to:
acquire an acoustic signal;
calculate a feature value representing a spectrum shape for each of a plurality of first frames obtained from the acoustic signal;
calculate a ratio of a likelihood of a voice model to a likelihood of a non-voice model for each of the plurality of first frames using the feature value as an input;
determine a candidate target voice section that is a section including a target voice by use of the ratio of a likelihood of a voice model to a likelihood of a non-voice model;
calculate a posterior probability of each of a plurality of phonemes using the feature value as an input;
calculate at least one of entropy and time difference of posterior probabilities of the plurality of phonemes for each of the plurality of first frames; and
specify a section to be changed to a section not including the target voice, out of the candidate target voice sections, by use of at least one of the entropy and the time difference of the posterior probabilities.
